(19) United States
(12) Patent Application Publication
(10) Pub. No.: US 2025/0372865 A1
(43) Pub. Date: Dec. 4, 2025

(54) DUAL-POLARIZED, HARDNESS-REINFORCED ANTENNA ARRAY FOR HARSH ENVIRONMENTS

(71) Applicant: Blue Canyon Technologies LLC, Lafayette, CO (US)

(72) Inventors: Ehab Etellisi, Aurora, CO (US); Miles Richman, Wylie, TX (US); Ervin Krauss, Boulder, CO (US); Matthew Carton, Chico, CA (US); Abraham Vollrath, Longmont, CO (US)

(21) Appl. No.: 18/678,817

(22) Filed: May 30, 2024

(51) Int. Cl. H01Q 1/50; H01Q 1/38

(52) U.S. Cl. CPC H01Q 1/50; H01Q 1/38

(57) ABSTRACT

Embodiments of the disclosure provide an antenna structure that includes antenna elements mechanically coupled to a non-dielectric substrate region of a faceplate. The antenna structure further includes a dual-polarity coupler electronically coupled to the antenna elements. The dual polarity coupler is operable to transmit a first type of electronic communication having a first polarity type, as well as a second type of electronic communication have a second polarity type. The antenna elements include exposed surfaces that include a first deformation resistant material.

### BACKGROUND

The present disclosure relates in general to antenna-based electronic communications systems deployed in harsh environments. More specifically, the present disclosure relates to a dual-polarized, hardness-reinforced antenna array for use in harsh environments. In some embodiments of the disclosure, the hardness-reinforced antenna array includes a deformation resistant material such as a metal; and the harsh environment includes a deep-space environment.

The terms “mission” and/or “exploration” have been used to describe human efforts to travel into unknown regions to discover and learn. Such missions/explorations have been on land over all types of terrains (e.g., mountains, caves, and the like); underground at various depths; through bodies of water at various depths; in the air within Earth's atmosphere; and beyond earth's atmosphere into space. As used herein, the terms “mission,” “exploration,” and equivalents thereof identify travel through and to any type of land-based, underground, water-based, earth-atmosphere-based, and space-based region for purposes of learning about such regions.

A non-limiting example of human exploration/missions is space exploration. A common type of space exploration uses astronomy and various forms of space technology to explore outer space. While this type of space exploration is carried out mainly by astronomers with telescopes, physical space exploration is conducted both by uncrewed robotic space probes and human spaceflight. Space exploration, like its classical form astronomy, is one of the main sources for space science. Deep-space exploration (i.e., a type of deep-mission exploration) is the branch of astronomy, astronautics and space technology that is involved with exploring the distant regions of outer space. Using Earth as the home planet, deep-space is the region of space beyond the dark side of Earth's Moon, including Lagrange 2 (or L2) (274,000 miles from Earth) and asteroids. L2 is one of five Sun-Earth Lagrange points, which are positions in space where the gravitational pull of the Sun and Earth combine such that small objects in that region have the same orbital period (length of year) as Earth. Some Lagrange points are being used for space exploration. Two important Lagrange points in the Sun-Earth system are L1, between the Sun and Earth, and L2, on the same line at the opposite side of the Earth. Both L1 and L2 are well outside the Moon's orbit. Currently, an artificial satellite called the deep space climate observatory (DSCOVR) is located at L1 to study solar wind coming toward Earth from the Sun and to monitor Earth's climate by taking images and sending them back. The James Webb Space Telescope, which is a powerful infrared space observatory, is located at L2. This allows the satellite's large sunshield to protect the telescope from the light and heat of the Sun, Earth and Moon.

For spacecraft that perform deep-space missions, antenna systems are used to establish the long-distance downlink-to-earth RF communication links while also supporting spacecraft operations. The long-distance communications path and harsh environmental conditions associated with deep-space missions present challenges when designing and implementing deep-space spacecraft antennas.

### BRIEF DESCRIPTION

Disclosed is an antenna structure that includes antenna elements mechanically coupled to a non-dielectric substrate region of a faceplate. The antenna structure further includes a dual-polarity coupler electronically coupled to the antenna elements. The dual polarity coupler is operable to transmit a first type of electronic communication having a first polarity type, as well as a second type of electronic communication have a second polarity type. The antenna elements include exposed surfaces that include a first deformation resistant material.

In addition to any one or more of the features described herein, the antenna structure further includes a feed network electronically coupled between the dual-polarity coupler and the antenna elements, where the feed network includes a second deformation resistant material

In addition to any one or more of the features described herein, the feed network is mechanically coupled to a dielectric substrate region of a feed network support, and the feed network support is mechanically coupled to the faceplate.

In addition to any one or more of the features described herein, the feed network is mechanically coupled to a non-dielectric substrate region of a feed network support, and the feed network support is mechanically coupled to the faceplate.

In addition to any one or more of the features described herein, the antenna structure further includes a backplane housing mechanically coupled to the feed network support, where the backplane housing includes a third deformation resistant material.

In addition to any one or more of the features described herein, the first deformation resistant material includes a first metal material; the second deformation resistant material includes a second metal material: and the third deformation resistant material includes a third metal material.

In addition to any one or more of the features described herein, the antenna elements comprise a first antenna element and a second antenna element; the non-dielectric substrate region of the faceplate includes a first cavity having cavity sidewalls; and the first antenna element is mechanically coupled to the non-dielectric substrate region of the faceplate through the first cavity such that a first cavity gap is defined between the first antenna element and the cavity sidewalls. A portion of the cavity sidewalls and a portion of the first cavity gap are between the first antenna element and the second antenna element. The portion of the first cavity sidewalls is operable to reduce mutual coupling between the first antenna element and the second antenna element.

Embodiments of the disclosure are also directed methods of forming and using the above-described antenna structure having substantially the same features, functionality, and combinations of features and functionality described above.

Disclosed is an antenna structure that includes an antenna array having antenna elements mechanically coupled to a non-dielectric substrate region of a faceplate. The antenna structure further includes a dual-polarity coupler electronically coupled to the antenna elements. The dual polarity coupler is operable to transmit a first type of electronic communication having a first polarity type, as well as a second type of electronic communication have a second polarity type. Each of the antenna elements includes exposed surfaces, and the exposed surfaces of each of the antenna elements include one or more types of a first deformation resistant material.

In addition to any one or more of the features described herein, the antenna structure further includes a feed network electronically coupled between the dual-polarity coupler and the antenna elements, where the feed network includes one or more types of a second deformation resistant material.

In addition to any one or more of the features described herein, the feed network is mechanically coupled to a dielectric substrate region of a feed network support, and the feed network support is mechanically coupled to the faceplate.

In addition to any one or more of the features described herein, the feed network includes a first feed network layer and a second feed network layer; a connection between the feed network and the second feed network layer does not comprises a via; and the feed network is mechanically coupled to a non-dielectric substrate region of a feed network support.

In addition to any one or more of the features described herein, the feed network is mechanically coupled to a non-dielectric substrate region of a feed network support, and the feed network support is mechanically coupled to the faceplate.

In addition to any one or more of the features described herein, the antenna structure further includes a backplane housing mechanically coupled to the feed network support, where the backplane housing includes one or more types of a third deformation resistant material.

In addition to any one or more of the features described herein, the first deformation resistant material includes a first metal material; the second deformation resistant material includes a second metal material: and the third deformation resistant material includes a third metal material.

In addition to any one or more of the features described herein, the antenna elements include a first antenna element and a second antenna element. The non-dielectric substrate region of the faceplate includes a top surface having a first cavity and a second cavity. The first antenna element is mechanically coupled to the non-dielectric substrate region of the faceplate through the first cavity, and the second antenna element is mechanically coupled to the non-dielectric substrate region of the faceplate through the second cavity.

Embodiments of the disclosure are also directed methods of using the above-described antenna structure and antenna array having substantially the same features, functionality, and combinations of features and functionality described above.

Disclosed is a method of forming an antenna structure. The method includes forming an antenna array having antenna elements mechanically coupled to a non-dielectric substrate region of a faceplate. The method further includes electronically coupling a dual-polarity coupler to the antenna elements. The dual polarity coupler is operable to transmit a first type of electronic communication having a first polarity type, as well as a second type of electronic communication have a second polarity type. Each of the antenna elements includes exposed surfaces, and the exposed surfaces of each of the antenna elements include one or more types of a first deformation resistant material.

In addition to any one or more of the features described herein, the method further includes electronically coupling a feed network between the dual-polarity coupler and the antenna elements, where the feed network includes one or more types of a second deformation resistant material.

In addition to any one or more of the features described herein, the feed network is mechanically coupled to a dielectric substrate region of a feed network support, and the feed network support is mechanically coupled to the faceplate.

In addition to any one or more of the features described herein, the feed network is mechanically coupled to a non-dielectric substrate region of a feed network support, and the feed network support is mechanically coupled to the faceplate.

In addition to any one or more of the features described herein, the first deformation resistant material includes a first metal material; and the second deformation resistant material includes a second metal material.

In addition to any one or more of the features described herein, the antenna elements include a first antenna element and a second antennal element. The non-dielectric substrate region of the faceplate includes a top surface having a first cavity and a second cavity. The first antenna element is mechanically coupled to the non-dielectric substrate region of the faceplate through the first cavity, and the second antenna element is mechanically coupled to the non-dielectric substrate region of the faceplate through the second cavity.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a simplified block diagram illustrating a deep-mission environment implemented as a space environment in which embodiments of the disclosure can be applied;

FIG. 2 illustrates an equation that can be used to represent or determine deformation-resistance and/or hardness of a material in accordance with aspects of the disclosure;

FIG. 3 depicts a table and a diagram/scale illustrating ranges for various gain levels provided by antenna structures in accordance with aspects of the disclosure;

FIG. 4 is a simplified block diagram illustrating a system in accordance with embodiments of the disclosure;

FIG. 5A is a simplified block diagram illustrating an antenna structure in accordance with embodiments of the disclosure;

FIG. 5B is a diagram illustrating how a portion of the antenna structure shown in FIG. 5A can be implemented in accordance with embodiments of the disclosure;

FIG. 6A is a simplified block diagram illustrating a side view of an antenna structure in accordance with embodiments of the disclosure;

FIG. 6B is a simplified block diagram illustrating a side view of an isolated portion of the antenna structure shown in FIG. 6A in accordance with embodiments of the disclosure;

FIG. 6C is a simplified block diagram illustrating a side view of an isolated portion of the antenna structure shown in FIG. 6A in accordance with embodiments of the disclosure;

FIG. 6D is a simplified block diagram illustrating a top-down view of an isolated portion of the antenna structure shown in FIG. 6A in accordance with embodiments of the disclosure;

FIG. 6E is a simplified block diagram illustrating a computer-based system operable to implement aspects of the disclosure;

FIG. 7 is a simplified block diagram illustrating aspects of an antenna structure in accordance with embodiments of the disclosure;

FIG. 8 is a simplified block diagram illustrating aspects of an antenna structure in accordance with embodiments of the disclosure;

FIG. 9 is a simplified block diagram illustrating aspects of an antenna structure in accordance with embodiments of the disclosure;

FIG. 10A is a simplified block diagram illustrating right-hand circular polarization (RHCP) in accordance with embodiments of the disclosure;

FIG. 10B is a simplified block diagram illustrating left-hand circular polarization (LHCP) in accordance with embodiments of the disclosure;

FIG. 11 is a simplified block diagram illustrating aspects of an antenna structure in accordance with embodiments of the disclosure;

FIG. 12A is a simplified block diagram illustrating aspects of an antenna structure in accordance with embodiments of the disclosure;

FIG. 12B is a simplified block diagram illustrating aspects of an antenna structure in accordance with embodiments of the disclosure;

FIG. 12A′ is a simplified block diagram illustrating aspects of an antenna structure with additional notations in accordance with embodiments of the disclosure;

FIG. 12B′ is a simplified block diagram illustrating aspects of an antenna structure with additional notations in accordance with embodiments of the disclosure;

FIG. 13A is a simplified block diagram illustrating right-hand circular polarization (RHCP) in accordance with embodiments of the disclosure;

FIG. 13B is a simplified block diagram illustrating left-hand circular polarization (LHCP) in accordance with embodiments of the disclosure;

FIG. 14 depicts details of an exemplary computing system capable of implementing various aspects of a system embodying aspects of the disclosure;

FIG. 15A depicts results of a simulation showing functionality of an HGA implementation of an antenna array in accordance with embodiments of the disclosure;

FIG. 15B depicts results of a simulation showing functionality of an HGA implementation of an antenna array in accordance with embodiments of the disclosure;

FIG. 15C depicts results of a simulation showing functionality of an HGA implementation of an antenna array in accordance with embodiments of the disclosure;

FIG. 15D depicts results of a simulation showing functionality of an HGA implementation of an antenna array in accordance with embodiments of the disclosure;

FIG. 15E depicts results of a simulation showing functionality of an HGA implementation of an antenna array in accordance with embodiments of the disclosure;

FIG. 16A depicts results of a simulation showing functionality of an HGA implementation of an antenna array in accordance with embodiments of the disclosure;

FIG. 16B depicts results of a simulation showing functionality of an HGA implementation of an antenna array in accordance with embodiments of the disclosure;

FIG. 16C depicts results of a simulation showing functionality of an HGA implementation of an antenna array in accordance with embodiments of the disclosure; and

FIG. 16D depicts results of a simulation showing functionality of an HGA implementation of an antenna array in accordance with embodiments of the disclosure.

### DETAILED DESCRIPTION

A detailed description of one or more embodiments of the disclosed apparatus and method are presented herein by way of exemplification and not limitation with reference to the Figures.

As previously noted herein, the terms “mission” and/or “exploration” have been used to describe human efforts to travel into unknown regions to discover and learn. Such missions/explorations have been on land over all types of terrains (e.g., mountains, caves, and the like); underground at various depths; through bodies of water at various depths; in the air within Earth's atmosphere; and beyond earth's atmosphere into space. Thus, the terms “mission” and/or “exploration” are used herein to identify any type of land-based, underground, water-based, earth-atmosphere-based, and space-based travel for purposes of learning about such regions.

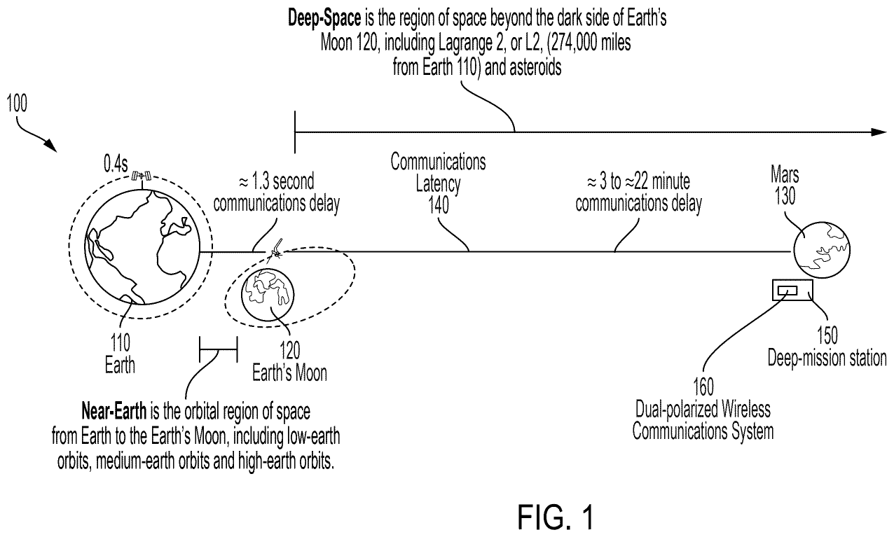

A non-limiting example of human exploration/mission activity is space exploration. A common type of space exploration uses astronomy and various forms of space technology to explore outer space. While this type of space exploration is carried out mainly by astronomers with telescopes, physical space exploration is conducted both by uncrewed robotic space probes and human spaceflight. Space exploration, like its classical form astronomy, is one of the main sources for space science. Deep-space exploration (i.e., a type of deep-mission exploration) is the branch of astronomy, astronautics and space technology that is involved with exploring the distant regions of outer space. FIG. 1 is a diagram illustrating relative positions of the Earth 110, the Earth's Moon 120 and Mars 130. Using the Earth 110 as the home planet, deep-space is the region of space beyond the dark side of Earth's Moon 120, including Lagrange 2 (or L2) (˜274,000 miles from the Earth 110) and asteroids. L2 is one of five Sun-Earth Lagrange points, which are positions in space where the gravitational pull of the Sun (not shown) and the Earth 110 combine such that small objects in that region have the same orbital period (length of year) as the Earth 110.

U.S. and international space authorities have ambitious spaceflight schedules through the mid-21st century, which include manned and unmanned deep-space exploration. An example deep exploration is depicted in FIG. 1 by the deep-mission station 150, which can be any type of manned or unmanned spacecraft that is within the atmosphere or on the surface of Mars 130. The deep-mission station 150 includes a dual-polarized wireless communications system 160, which can be implemented to include features and functionality of various aspects of the present disclosure. In addition to functionality, spacecraft systems should meet both durability and reliability standards. This is particularly true for antenna system that are mounted to the exterior of the spacecraft. In general, antennas used in space applications must withstand harsh environmental effects due to launching activity and the space environment. During spacecraft launch, acoustic vibrations, shocks, mechanical stress based on static loads, dynamic loads and sudden atmospheric pressure fall occur. In addition, in the commissioning phase, pyrotechnical shocks are generated while deploying solar panels and payloads like deployable antennas. All of these conditions can adversely affect antenna systems attached to the spacecraft surface. After spacecraft launch, antenna systems are exposed to harsh space environmental conditions, including exposure to extreme heat and cold cycling, ultrahigh vacuum, atomic oxygen, high-energy radiation, and debris impact. Additionally, as shown in FIG. 1, the communication latency 140 for electronic information transmitted between the Earth 110 and Mars 130 ranges from about three (3) to about twenty-two (22) minutes each way, depending on a variety of factors. In comparison, the communications delay 140 for electronic information transmitted between Earth and a satellite in near-Earth orbit is about 1.3 seconds. Thus, antenna systems in deep-space missions need sufficient gain functionality to receive and transmit signals over a communications path having the communications latency 140.

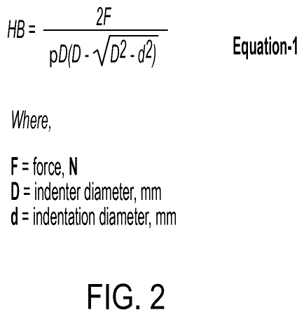

Turning now to an overview of aspects of the disclosure, exemplary embodiments of the disclosure address the above-described issues by providing a novel dual-polarized, hardness-reinforced antenna array for use in harsh environments. In accordance with embodiments of the disclosure, the novel dual-polarized, hardness-reinforced antenna array can be incorporated within the dual-polarized wireless communications system 160 of the deep-mission station 150 shown in FIG. 1. In some embodiments of the disclosure, the hardness-reinforced antenna array includes a deformation resistant material such as a metal; and the harsh environment includes a deep-space environment. A common hazard in harsh space environments is collisions with moving objects in space. In embodiments of the disclosure, the deformation resistant material is a material that can absorb a relatively large one-time impact without substantial deformation of the impacted surface. The deformation resistant material's ability to absorb a relatively large one-time impact without substantial deformation of the impacted surface can be measured by the deformation resistant material's hardness. The SI unit of hardness is the Newton per square millimeter (N/mm²). A variety of known testing methods can be used to determine a material's hardness. A commonality among all such testing methods is the use of an indenter to create an indentation on a test piece surface area. The indentation provides a tangible representation of the hardness of the material, and it is relatively easy to measure and replicate. A suitable testing method for measuring hardness is the Brinell hardness (BH) test, which measures hardness in so-called BH units according to Equation-1 depicted in FIG. 2. BH units can be converted to N/mm² and vice versa. In accordance with embodiments of the disclosure, a deformation resistant material has a BH ranging from about 80 to about 165. In embodiments of the disclosure where the deformation resistant material is a metal, suitable metals include aluminum, brass and steel. In some embodiments of the disclosure where the deformation resistant material is a metal, suitable metals known commercially as 6061-T6 aluminum, 7075-T73 aluminum, C360 brass, and stainless steel.

In some embodiments of the disclosure, the hardness-reinforced antenna array can be implemented as a high-gain antenna (HGA) array. In some embodiments of the disclosure, the hardness-reinforced antenna array can be implemented as a medium-gain antenna (MGA) array. In some embodiments of the disclosure, the hardness-reinforced HGA array can be implemented as an 8×8 array of sixty-four (64) dual-polarized patch antenna elements mounted on a non-dielectric faceplate. In some embodiments of the disclosure, the hardness-reinforced MGA array can be implemented as a 4×4 array of sixteen (16) dual-polarized patch antenna elements mounted on a non-dielectric faceplate. In general, the number of antennas elements within the array control the gain level. For ease of description, the present disclosure references features and functionality of hardness-reinforced HGA arrays and/or hardness-reinforced MGA arrays in accordance with embodiments of the disclosure. However, each feature and functionality described in connection with a HGA implementation of embodiments of the disclosure apply equally to MGA implementations of embodiments of the disclosure, and vice versa.

Conventional implementations of patch antennas in an antenna array include the use printed circuit board (PCB) fabrication techniques to form the patch antenna in a dielectric substrate. While forming patch antennas in a dielectric substrate would reduce the overall weight of the antenna array and leverage well established such PCB fabrication techniques, the dielectric material is not deformation-resistant and causes electrostatic discharge when combined with the metal antenna/grounding components of the antenna array. Embodiments of the disclosure avoid the shortcomings of dielectric substrates by mechanically coupling the dual-polarized patch antenna elements to the previously-described non-dielectric faceplate. Securing the dual-polarized patch antenna elements to the non-dielectric faceplate instead of a dielectric substrate mitigates the impact of electrostatic discharge, extreme cold/hot temperature conditions, and high particle radiation levels on antenna performance and the material's structural integrity that would result from the presence of a dielectric substrate instead of the non-dielectric faceplate. More specifically, forming the dual-polarized patch antenna elements from deformation-resistant material (e.g., one or more types of a metal or a metal alloy) and forming the faceplate from a non-dielectric material help to reduce the negative antenna performance that would result from the frequency shifting that results from the presence of dielectric materials around the dual-polarized patch antenna elements of the antenna array.

In embodiments of the disclosure, the non-dielectric faceplate has formed therein a plurality of cavity cells, and each of the deformation-resistant dual-polarized patch antenna elements is secured inside one of the cavity cells by mechanically coupling the deformation-resistant planar dual-polarity patch antenna element to a bottom surface of its corresponding cavity cell. In embodiments of the disclosure, the deformation-resistant dual-polarity antenna element is sized such that it does not completely fill its associated cavity cell and is spaced away from one or more sidewalls of the cavity cell, thereby forming at least one cavity gap between the deformation-resistant dual-polarity patch antenna element and one or more sidewalls of the cavity cell. Accordingly, each deformation-resistant, dual-polarity antenna element is separated from other deformation-resistant, dual-polarity antenna elements in the array by a gap (or air gap) and a cavity sidewall. In embodiments of the disclosure, the dimensions and locations of the cavity gaps and cavity sidewalls are selected to decrease the non-desired coupling from one deformation-resistant dual-polarity antenna element in the antenna array to the surrounding deformation-resistant dual-polarity antenna elements in the antenna array. In embodiments of the disclosure, the dimensions and locations of the cavity gaps and cavity sidewalls are further selected such that the cavity sidewalls and cavity gaps do not negatively impact the performance of each deformation-resistant, dual-polarity antenna element in the array.

In addition to the 8×8 array of sixty-four (64) deformation-resistant dual-polarized patch antenna elements mounted on a non-dielectric faceplate, in some embodiments of the disclosure, the hardness-reinforced HGA array further includes a feed network electronically coupled to the deformation-resistant dual-polarized patch antenna elements and mechanically coupled to and supported by a feed network housing/support. The non-dielectric faceplate is mechanically coupled to the feed network housing/support. Two separately-polarized connectors are coupled at one end to the feed network and at another end to downstream components (e.g., transceiver 230 shown in FIG. 2) of the dual-polarized wireless communications system 160 (shown in FIG. 1). An optional deformation resistant backplane housing/cover can be mechanically coupled to the feed network housing/support.

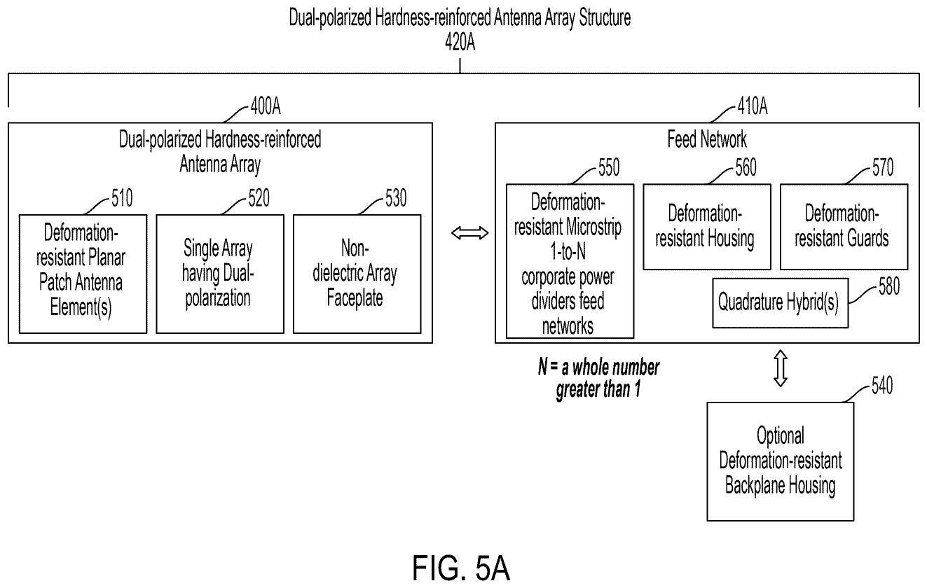

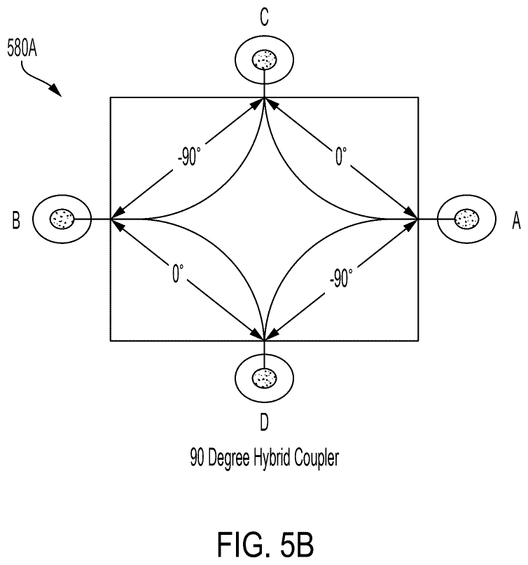

In embodiments of the disclosure, some or all of the above-described components of the hardness-reinforced HGA array are hardness-reinforced in that some or all of each component is formed from a deformation-resistant material such as one or more types of a metal and/or a metal alloy. In some embodiments of the disclosure, the entire component (e.g., the deformation-resistant planar patch antenna element(s) 510 shown in FIG. 5A) is formed from deformation-resistant material. In some embodiments of the disclosure, a main body region of the component (e.g., the deformation-resistant planar patch antenna element(s) 510 shown in FIG. 5A) is formed from a relatively light weight material (e.g., a light weight, non-dielectric material) and the exposed surfaces of the main body region of the component is formed from a deformation-resistant material.

In some embodiments of the disclosure, some or all of the above-described components of the hardness-reinforced HGA array are formed from material that is both deformation-resistant and non-dielectric material. Non-dielectric material mitigates the impact of electrostatic discharge, extreme cold/hot temperature conditions, and high particle radiation levels on antenna performance and the material's structural integrity. More specifically, forming the dual-polarized patch antenna elements from deformation-resistant material (e.g., one or more types of a metal or a metal alloy) and forming the faceplate from non-dielectric material help to reduce the negative antenna performance that can result from the frequency shifting that results from the presence of dielectric materials in the HGA array. In some embodiments of the disclosure, the weight of the hardness-reinforced HGA array can be reduced by forming selected portions of the above-described feed network housing/support from a dielectric material substrate and using PCB fabrication technologies to form the feedback network within the dielectric material substrate. In some embodiments of disclosure, the feed network is provided in a single layer of transmission lines (or traces) that is mechanically coupled to one side of the feed network housing/support. In some embodiments of disclosure, the feed network is provided in two layers, a first one of the two feed network layers is mechanically coupled to a first side of the feed network housing/support, and a second one of the two feed network layers is mechanically coupled to a second, opposite side of the feed network housing/support. In some embodiments of the disclosure, the feed network housing/support can be formed to include a dielectric substrate region where the first one of the two layers is formed (using PCB fabrication techniques) in or on a first side of the dielectric substrate region, and the second one of the two layers is formed (also using PCB fabrication techniques) in or on a second, opposite side of the dielectric substrate region. In either the single layer feed network or the two layer feed network, the need for vias connecting multiple feed network layers is eliminated, which decreases the risk of thermal and vibration failure during the actual mission, spacecraft lunching, or through qualifications testing.

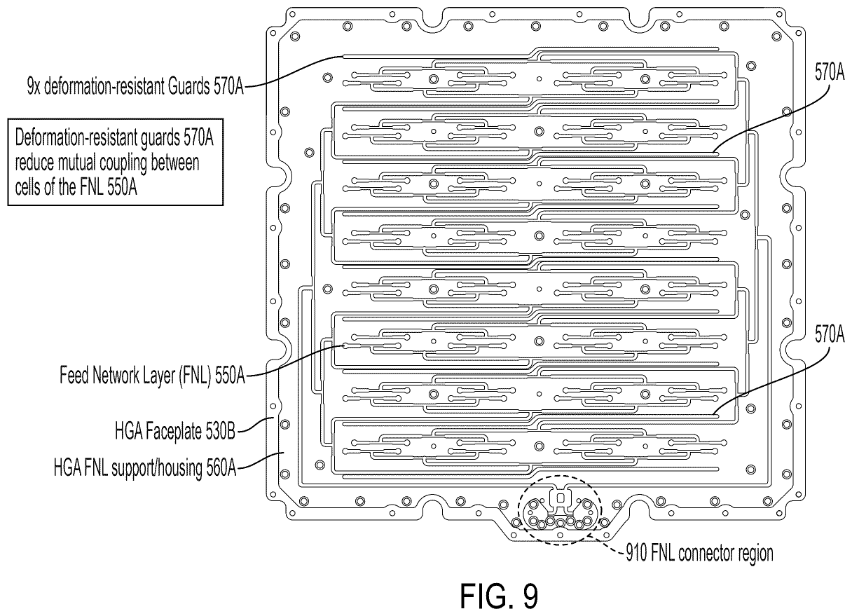

In some embodiments of the disclosure, the feed network can be formed from microstrips. In general, a microstrip is a type of electrical transmission line. In known implementations, microstrips can be fabricated with any technology where a conductor is separated from a ground plane by a dielectric layer known as a “substrate.” Microstrip lines are used to convey microwave-frequency signals used by microwave components such as antennas, couplers, filters, power dividers and the like. In embodiments of the disclosure where the one or more layers of the feed network are mechanically mounted to a non-dielectric feed network housing/support, metal guards (e.g., metal guards 570A shown in FIG. 9) are provided at selected locations of the feed network to reduce mutual coupling between sections of the feed network. The metal guards can help reduce the element-to-element surface current coupling, improve the field of view gain patterns over different azimuthal cuts, and reduce the array edge effect by enforcing the symmetry around each antenna element within the array.

In some embodiments of the disclosure, the two separately-polarized connectors can be implemented as two sub-miniature version A (SMA) semi-precision coaxial RF connectors. The two separately-polarized connectors are excited to provide substantially the same amplitude and phase excitations to each dual-polarized patch antenna element. Additionally, the two separately-polarized connectors are excited with two orthogonal phases to enable dual and circular polarization capability. More specifically, the two separately-polarized connectors are configured such that a first one of the two separately-polarized connectors couples a first type of electronic communication having a first polarity type; and a second one of the two separately-polarized connectors couples a second type of electronic communication have a second polarity type. In some embodiments of the disclosure, the first polarity type includes right hand circular polarization (RHCP), and the second polarity type includes left hand circular polarization (LHCP). Accordingly, each dual-polarized patch antenna element coupled to the two separately-polarized connectors can be excited with two orthogonal phases, thereby enabling a single patch antenna element to transmit/receive multiple polarity types, and eliminating the need to provide a separate patch antenna element for each polarity type. The ability to transmit/receive multiple polarity types through a single patch antenna element increases the bandwidth capability of the single patch antenna element.

A variety of suitable materials can be used to form a hardness-reinforced HGA/MGA array in accordance with some embodiments of the disclosure. For example, in some embodiments of the disclosure, the dual-polarized patch antenna elements can be made of C360 brass then gold plated per ASTM-B-488-11 with 0.3-0.5 gm thick over electroless nickel plate per ASTM-B-733-04. In some embodiments of the disclosure, the dielectric substrate region of the feed network housing/support can be implemented as about 30-mil thick ceramic-filled polytetrafluoroethylene (PTFE) composite that has a dielectric constant of about 2.94 and a dissipation factor of about 0.0012. The thermal coefficient of the dielectric constant can be about −50° C./+125° C.

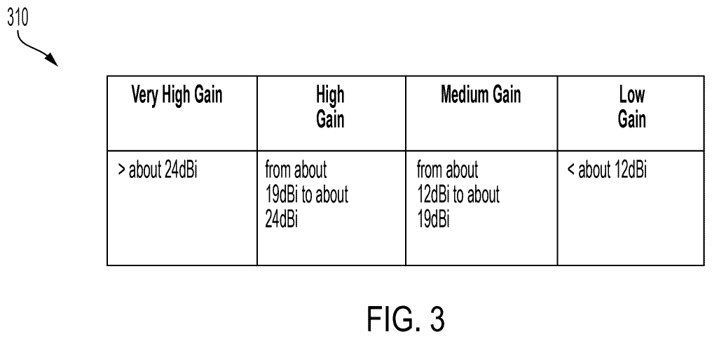

The hardness-reinforced HGA/MGA arrays disclosed herein broadcast a modulated electromagnetic signal within some defined bandwidth. The electromagnetic power radiated from an antenna is not always isotropic (uniformly distributed in space). Instead, taking into account the polar coordinate system, the radiation pattern around an antenna can be somewhat focused along specific directions. When working with antenna arrays, the radiation pattern can be very tightly focused. The level of focusing is known as antenna gain. The antenna gain can be calculated using two quantities, namely, radiation efficiency (η) and directivity (D). Radiation efficiency (η) is defined as the ratio of total radiated power to total input power. A perfect radiator would have efficiency of 100%. Directivity (D) is defined as the maximum emitted power (per steradian) divided by the total radiated power. Thus, the antenna gain can be expressed as the product of these quantities, G=ηD. A well-designed antenna and matching network will have n very close to 100%. Gain is normally expressed in a decibel unit, dBi, by comparing G to the gain of an isotropic antenna. By definition, G=1 for an isotropic antenna, so gain in dBi=10log(ηD), making it equivalent to a standard decibel unit. The ranges for very high gain, high gain, medium gain, and low gain are depicted by the table 310 shown in FIG. 3.

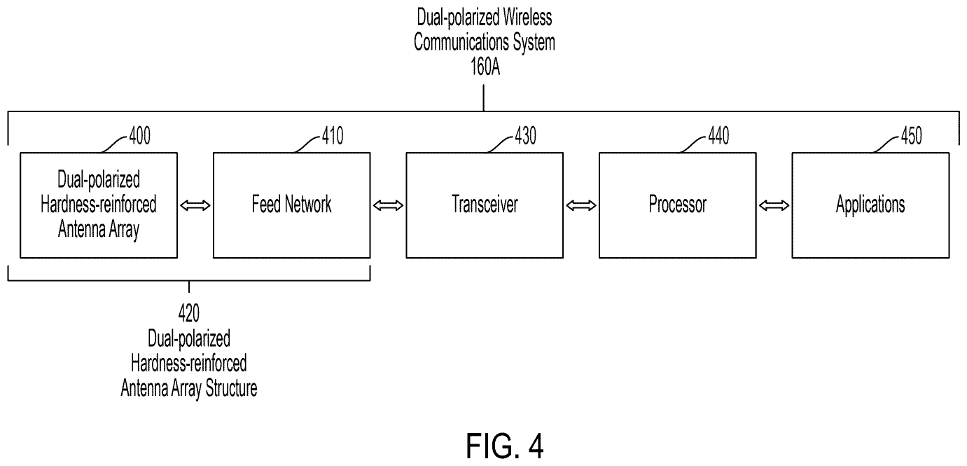

Turning now to a more detailed description of embodiments of the disclosure, FIG. 4 depicts a simplified block diagram illustrating a non-limiting example of a novel dual-polarized wireless communications system 160A in accordance with aspects of the disclosure. The system 160A is a non-limiting example of how the dual-polarized wireless communications system 160 (shown in FIG. 1) can be implemented in accordance with aspects of the disclosure. The system 160A can be implemented in a variety of mission/exploration environments, including interplanetary spacecraft missions, radio astronomy, radar astronomy and related exploration of the solar system and universe. All of these missions/environments utilize antenna-based wireless communications systems to successfully establish and maintain RF communications with other systems.

As shown in FIG. 4, the novel dual-polarized wireless communications system 160A includes a dual-polarized hardness-reinforced antenna array structure 420, a transceiver 430, a processor 440 and an applications module 450, configured and arranged as shown. In accordance with aspects of the disclosure, the dual-polarized hardness-reinforced antenna array structure 420 includes a dual-polarized hardness-reinforced antenna array 400 electronically and mechanically coupled to a feed network 410. The system 160A is configured to transmit and receive wireless signals. When functioning as a receiver, wireless signals in the form of radio waves are intercepted by the dual-polarized hardness-reinforced antenna array 400, which acts as a type of transducer that converts power associated with the intercepted radio waves to electric current (e.g., modulated AC) that is passed through the feed network 410 to the transceiver 430. The feed network 410 includes conductors (e.g., transmission lines and/or traces) and other associated elements, which electronically connect the dual-polarized hardness-reinforced antenna array 400 with the transceiver 430 and make the two components 400, 430 compatible. Each type of conductor line in the feed network 410 has a specific characteristic impedance, which must be matched to the impedance of the dual-polarized hardness-reinforced antenna array 400 and the transceiver 430 to transfer power efficiently to and from the dual-polarized hardness-reinforced antenna array 400. If these impedances are not matched, it can cause a condition called standing waves on the feed network 410 in which the radio wave energy is reflected back toward the dual-polarized hardness-reinforced antenna array 400 or the transceiver 430, thereby wasting energy and possibly overheating the transceiver 430. Impedance matching adjustments can be done with a device called an antenna tuner in the transceiver 430, or alternatively, with a device called a matching network at the dual-polarized hardness-reinforced antenna array 400. The feed network 410 can include circuitry (e.g., antenna tuning units, or matching networks) that impedance matches the dual-polarized hardness-reinforced antenna array 400, the feed network 410, and the transceiver 430.

The transceiver 430 receives the electric signals (e.g., modulated AC) signals from the feed network 410. The transceiver 430 can include, for example, filters, and demodulators operable to extract the desired information from the electronic signals. The filters separate the desired frequency signal from all the other signals picked up by the antenna; the amplifier increases the power of the signal for further processing; and the demodulator demodulates the filtered, amplified signal to recover the desired information therefrom. The recovered information produced by the transceiver 430 can be in a variety of forms, including sound, video, digital data, and the like. The processor 440 receives the recovered information from the transceiver 430 and further prepares it for use by the applications 450. For example, where the recovered information is video with synchronized audio, the processor 440 prepares the recovered video/audio information, and the applications 450 include a component (e.g., a display) that actually uses or conveys the video/audio information to a user.

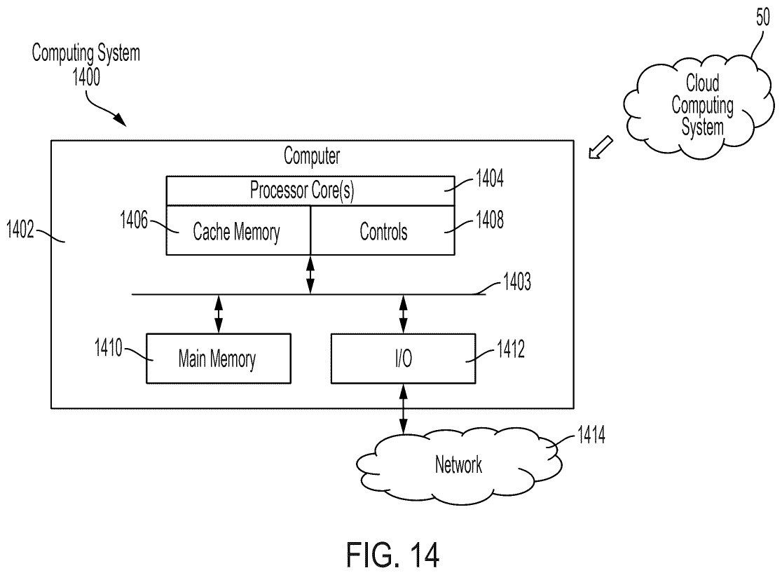

The transceiver 430, the processor 440, and the applications 450 are depicted separately for ease of illustration and explanation. However, the functionality of these components can be provided in any combination. For example, the processor 440 can be a distributed processor having processor functionality provided throughout the components of the dual-polarized wireless communications system 160A. In some embodiments of the disclosure, the processor 440 can include features and functionality of the computing system 1400 (shown in FIG. 14).

When the dual-polarized wireless communications system 160A functions as a transmitter, substantially the same receiver operation described above are performed but in reverse, where the processor 440 modulates the desired information onto a signal (e.g., modulated AC) and passes the modulated signal through the impedance matching element(s) of the transceiver 430, the feed network 410 and the dual-polarized hardness-reinforced antenna array 400. The dual-polarized hardness-reinforced antenna array 400 converts the modulated signal to electromagnetic waves (e.g., radio waves) and transmits the same.

FIG. 5A depicts a simplified block diagram illustrating a non-limiting example of a novel dual-polarized hardness-reinforced antenna array structure 420A in accordance with aspects of the disclosure. The dual-polarized hardness-reinforced antenna array structure 420A is a non-limiting example of how the dual-polarized hardness-reinforced antenna array structure 420 (shown in FIG. 4) can be implemented in accordance with aspects of the disclosure. The dual-polarized hardness-reinforced antenna array structure 420A includes a deformation-resistant planar patch antenna array 400A, along with a feed network 410A. The deformation-resistant planar patch antenna array 400A is a non-limiting example of how the deformation-resistant planar patch antenna array 400 (shown in FIG. 4) can be implemented in accordance with aspects of disclosure; and the feed network 410A is a non-limiting example of how the feed network 410 (shown in FIG. 4) can be implemented in accordance with aspects of the disclosure.

The deformation-resistant planar patch antenna array 400A includes deformation-resistant planar patch antenna element(s) 510, a single array having dual-polarization 520, and an array faceplate 530. The feed network 410A includes deformation-resistant microstrip 1-to-N corporate power divider feed networks 550, a deformation-resistant housing 560, deformation-resistant guards 570, and quadrature hybrid(s) 580. An optional deformation-resistant backplane housing 540 can be mechanically coupled to the deformation-resistant housing 560 of the feed network 410A.

The deformation-resistant planar patch antenna element(s) 510 can be implemented as a patch antenna element having deformation resistant material. A patch antenna is a type of antenna with a low profile, which can be mounted on a surface. It is conventionally formed as a planar rectangular, circular, triangular, or any geometrical sheet or “patch” of metal, which is mounted over a larger sheet of metal called a ground plane. The planar metal patch antenna and the ground plane together form a resonant piece of microstrip transmission line with a length of approximately one-half wavelength of the radio waves. The radiation mechanism arises from fringing fields along the radiating edges of the two metal components. The patch antenna is mainly practical at microwave frequencies because microwave frequencies are short enough that the patches can be made conveniently small.

Conventional implementations of patch antennas use PCB fabrication techniques to form the patch antenna in a dielectric substrate. While forming patch antennas in a dielectric substrate would reduce the overall weight of the antenna array 400A and leverage well established such PCB fabrication techniques, the dielectric material is not deformation-resistant and causes electrostatic discharge when combined with the metal antenna/grounding components of the antenna array. Embodiments of the disclosure avoid this shortcomings of using dielectric substrates techniques by mechanically coupling the deformation-resistant planar patch antenna elements 510 to the non-dielectric array faceplate 530. Securing the deformation-resistant planar patch antenna elements 510 to the non-dielectric array faceplate 530 instead of a dielectric substrate mitigates the impact of electrostatic discharge, extreme cold/hot temperature conditions, and high particle radiation levels on antenna performance and the material's structural integrity that would result from the presence of a dielectric substrate instead of the non-dielectric array faceplate 530. More specifically, forming the dual-polarized patch antenna elements from deformation-resistant material (e.g., one or more types of a metal or a metal alloy) and forming the array faceplate 530 from a non-dielectric material help to reduce the negative antenna performance that would result from the frequency shifting that results from the presence of dielectric materials in the dual-polarized hardness-reinformed antenna array 400A.

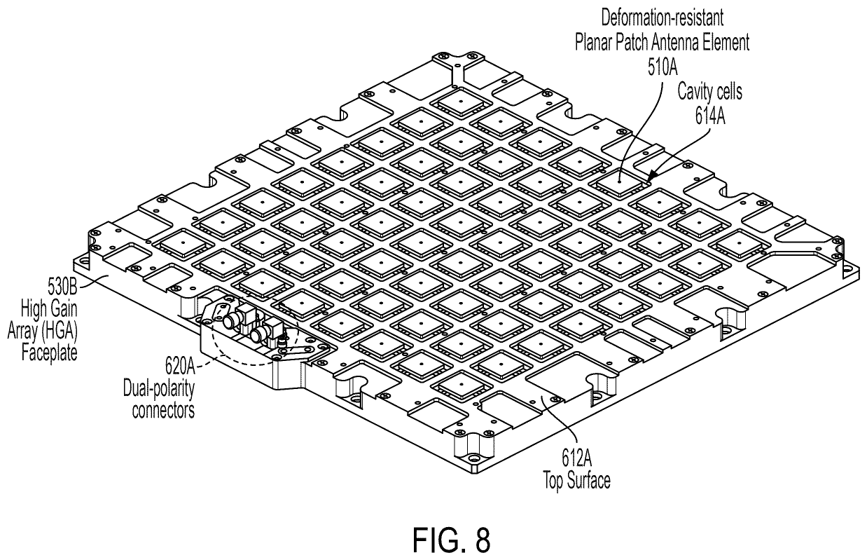

The single array having dual polarization 520 is implemented by configuring each deformation-resistant planar patch antenna element 510 such that it is excited by two separately-polarized connectors (e.g., dual-polarity connectors 620A shown in FIG. 8). The two separately-polarized connectors are excited to provide substantially the same amplitude and phase excitations to each deformation-resistant planar patch antenna element 510. With one array and two separately-polarized connectors, the array can excite the right-handed circular polarization (RHCP) or/and the left-handed circular polarization (LHCP). This allows maximization of the throughput by using both ports, and allows the re-use of frequencies by transmitting and/or receiving at different frequency with higher isolation. Using a single array with two polarizations instead of having two arrays leads to a reduction in the overall cost, size, and weight for the utilized application. Additionally, the two separately-polarized connectors are excited with two orthogonal phases to enable dual and circular polarization capability. More specifically, the two separately-polarized connectors are configured such that a first one of the two separately-polarized connectors couples a first type of electronic communication having a first polarity type to each deformation-resistant planar patch antenna element 510; and a second one of the two separately-polarized connectors couples a second type of electronic communication have a second polarity type to each deformation-resistant planar patch antenna element 510. In some embodiments of the disclosure, the first polarity type includes right hand circular polarization (RHCP), and the second polarity type includes left hand circular polarization (LHCP). Accordingly, each deformation-resistant planar patch antenna element 510 coupled to the two separately-polarized connectors can be excited with two orthogonal phases, thereby enabling each of the deformation-resistant planar patch antenna elements 510 to transmit/receive multiple polarity types, and eliminating the need to provide a separate patch antenna element for each polarity type. The ability to transmit/receive multiple polarity types through each of the deformation-resistant planar patch antenna elements 510 increases the bandwidth capability of each of the deformation-resistant planar patch antenna elements 510.

In the feed network 410A, the deformation-resistant microstrip 1-to-N corporate power divider feed networks 550 are configured and arranged to include microstrips. In general, a microstrip is a type of electrical transmission line. Microstrip lines are used to convey microwave-frequency signals used by microwave components such as antennas, couplers, filters, power dividers and the like. The deformation-resistant microstrip 1-to-N corporate power divider feed networks 550 is implanted in a corporate feed network configuration where the power is equally split at each junction of each deformation-resistant planar patch antenna element 510 for uniform distribution.

The deformation-resistant housing 560 is operable to house or support the deformation-resistant microstrip 1-to-N corporate power divider feed networks 550. In some embodiments of the disclosure, some or all of the deformation-resistant housing 560 is formed from material that is both deformation-resistant and non-dielectric material. Non-dielectric material mitigates the impact of electrostatic discharge, extreme cold/hot temperature conditions, and high particle radiation levels on antenna performance and the material's structural integrity. More specifically, forming the deformation-resistant housing 560 from material that is deformation-resistant material and non-dielectric (e.g., one or more types of a metal or a metal alloy) helps to reduce the negative antenna performance that can result from the frequency shifting that results from the presence of dielectric materials in the dual-polarized hardness-reinformed antenna array structure 420A. In some embodiments of the disclosure, the weight of the dual-polarized hardness-reinforced antenna array structure 420A can be reduced by forming selected portions of the deformation-resistant housing 560 from a dielectric material substrate and using printed circuit board (PCB) fabrication technologies to form the deformation-resistant microstrip 1-to-N corporate power dividers feed networks 550 within the dielectric material substrate. In some embodiments of disclosure, the deformation-resistant microstrip 1-to-N corporate power dividers feed network 550 is provided in a single layer that is mechanically coupled to one side of the deformation-resistant housing 560. In some embodiments of disclosure, the deformation-resistant microstrip 1-to-N corporate power dividers feed network 550 is provided in two layers, where a first one of the two layers is mechanically coupled to a first side of the deformation-resistant housing 560, and where a second one of the two layers is mechanically coupled to a second, opposite side of the deformation-resistant housing 560. In some embodiments of the disclosure, the deformation-resistant housing 560 can be formed to include a dielectric substrate region where the first one of the two layers is formed (using PCB fabrication techniques) in or on a first side of the dielectric substrate region, and the second one of the two layers is formed (also using PCB fabrication techniques) in or on a second, opposite side of the dielectric substrate region. In either the single layer feed network or the two layer feed network, the need for vias connecting multiple feed network layers is eliminated, which decreases the risk of thermal and vibration failure during the actual mission, spacecraft lunching, or through qualifications testing. In embodiments of the disclosure where the one or more layers of the deformation-resistant microstrip 1-to-N corporate power dividers feed network 550 are mechanically mounted to a non-dielectric deformation-resistant housing 560, the metal guards 570 (e.g., metal guards 570A shown in FIG. 9) are provided at selected locations of the deformation-resistant microstrip 1-to-N corporate power dividers feed network 550 to reduce mutual coupling between sections or cells of the deformation-resistant microstrip 1-to-N corporate power dividers feed network 550. In some embodiments of the disclosure, the quadrature hybrid(s) 580 is an element operable to provide a +/−90 degree phase difference and allow the RHCP and LHCP capability. In some embodiments of the disclosure, the quadrature hybrid(s) 580 can be implemented as a 90° hybrid coupler 580A shown in FIG. 5B. The 90° hybrid coupler 580A includes four port devices that split an input signal equally between two output ports with a 90 degree phase difference between them. As seen in FIG. 5B, an input signal is fed from port A, equal amplitude signals are generated at ports C & D with 90° phase difference. Port B is isolated. In some embodiments of the disclosure, the metal guards 570 and/or the quadrature hybrid(s) 580 can be incorporated within the deformation-resistant microstrip 1-to-N corporate power dividers feed network 550.

The optional deformation-resistant backplane housing 540 can be mechanically coupled to a back end/side of the dual-polarized hardness-reinforced antenna array 400A to reduce to reduce the radiation coupling to other nearby antennas (e.g., other antennas on the deep-mission station 150 shown in FIG. 1) and provide extra environmental protection to the feed network 410A. To decrease the complexity and weight, this backplane housing can be removed from the design.

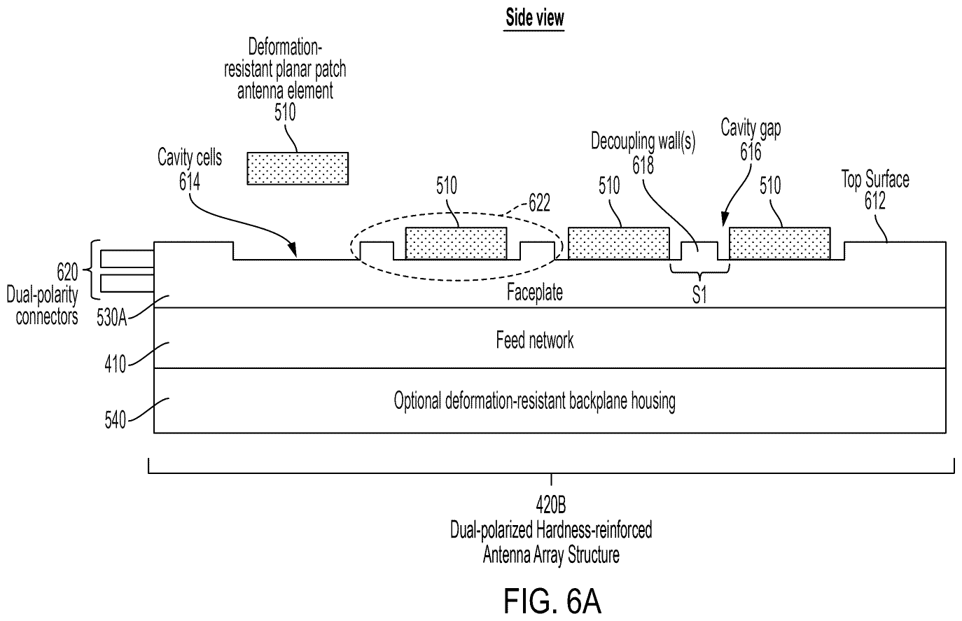

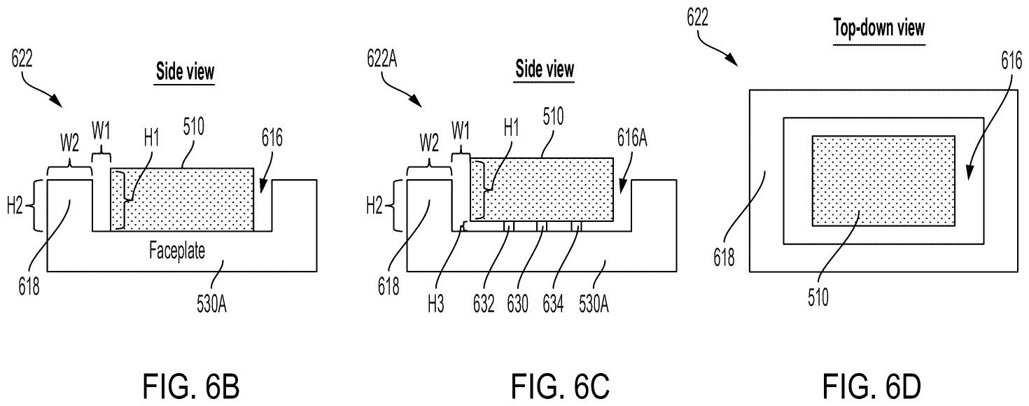

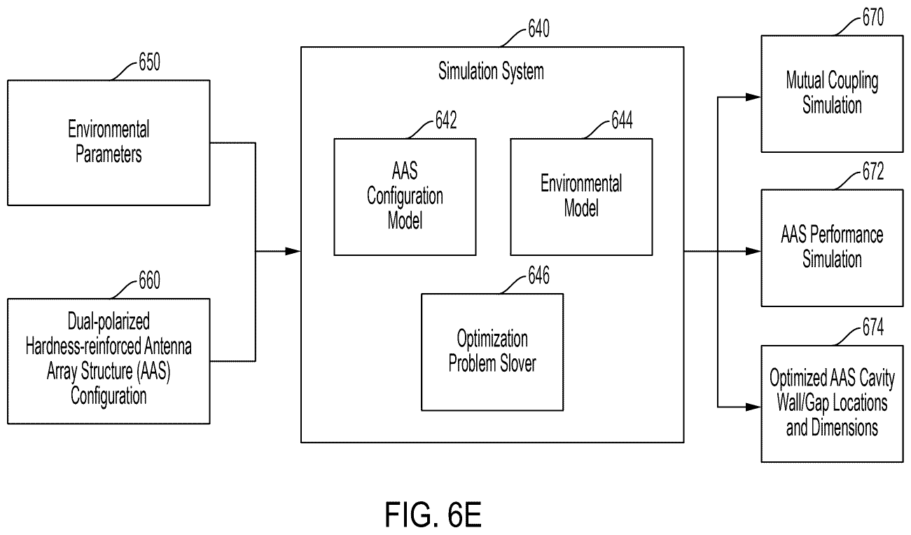

FIG. 6A depicts a simplified block diagram illustrating a side view of a non-limiting example of a novel dual-polarized hardness-reinforced antenna array structure 420B in accordance with aspects of the disclosure. The dual-polarized hardness-reinforced antenna array structure 420B is a non-limiting example of how the dual-polarized hardness-reinforced antenna array structure 420A (shown in FIG. 5A) can be implemented in accordance with aspects of the disclosure. The dual-polarized hardness-reinforced antenna array structure 420B includes a plurality of the deformation-resistant planar patch antenna elements 510, a faceplate 530A, the feed network 410, and the optional deformation-resistant backplane housing 540, configured and arranged as shown. The deformation-resistant planar patch antenna elements 510, the feed network 410, and the optional deformation-resistant backplane housing 540 can be implemented have the features and functionality previously described herein for these components. Additionally, in dual-polarized hardness-reinforced antenna array structure 420B, the deformation-resistant planar patch antenna elements 510 are mechanically coupled to the faceplate 530A; the faceplate 530A is mechanically coupled to a feed network support/housing (e.g., deformation-resistant housing 560 shown in FIG. 5A) of the feed network 410; and the feed network support/housing (e.g., deformation-resistant housing 560 shown in FIG. 5A) of the feed network 410 is mechanically coupled to the optional deformation-resistant backplane housing 540.

The faceplate 530A depicted in FIG. 6A provides a non-limiting example of how the faceplate 530 (shown in FIG. 5A) can be implemented in accordance with aspects of the disclosure. In embodiments of the disclosure, the faceplate 530 is formed from deformation-resistant, non-dielectric material and includes a top surface 612 (which can, in some embodiments of the disclosure, be substantially planar), a plurality of cavity cells 614, and a set of dual-polarity connectors 620, configured and arranged as shown. To better illustrate the cavity cells 614, a leftmost instance of the deformation-resistant planar patch antenna elements 510 is depicted as removed from and elevated above its associated cavity cell 614. In some embodiments of the disclosure, each of the deformation-resistant planar patch antenna elements 510 is secured inside one of the cavity cells 614 by mechanically coupling the deformation-resistant planar patch antenna element 510 to a bottom surface of its corresponding cavity cell 614. In embodiments of the disclosure, the deformation-resistant planar patch antenna element 510 is sized such that it does not completely fill its associated cavity cell 614 and is spaced away from one or more sidewalls 618 of the cavity cell 614, thereby forming at least one cavity gap 616 between the deformation-resistant planar patch antenna element 510 and one or more sidewalls 618 of the cavity cell 614. Accordingly, each deformation-resistant planar patch antenna element 510 is separated from other deformation-resistant planar patch elements 510 in the array structure 420B by a cavity gap (or air gap) 616 and a cavity sidewall 618. In embodiments of the disclosure, the dimensions and locations of the cavity gaps 616 and the cavity sidewalls 618 (including, specifically, the height of the cavity sidewalls 618) are selected to decrease the non-desired coupling from one deformation-resistant planar patch antenna element 510 in the antenna array 420B to the surrounding deformation-resistant planar patch antenna elements 510 in the antenna array structure 420B. In embodiments of the disclosure, the dimensions and locations of the cavity gaps 616 and cavity sidewalls 618 (including, specifically, the height of the cavity sidewalls 618) are further selected such that the cavity sidewalls 618 and cavity gaps 616 do not negatively impact the performance of each deformation-resistant planar patch antenna element 510 in the array structure 420B. Accordingly, the cavity sidewalls 618 are also referred to herein as decoupling sidewalls 618.

FIG. 6B is a simplified block diagram illustrating a side view of an isolated portion 622 (shown in FIGS. 6A and 6B) of the antenna structure 420B (shown in FIG. 6A) in accordance with embodiments of the disclosure. FIG. 6B illustrates a height dimension (H2) and a width dimension (W2) of the of the cavity wall 618. FIG. 6B also illustrates a height dimension (H1) and a width dimension (W1) of the of the cavity gap 616. FIG. 6C is a simplified block diagram illustrating a side view of an isolated portion 622A of the antenna structure 420B (shown in FIG. 6A) in accordance with embodiments of the disclosure. The isolated portion 622A is substantially the same as the isolated portion 622 except the deformation-resistant planar patch antenna element 510 is mechanically coupled to and lifted above a bottom surface of the cavity cell 614 (best shown in FIG. 6A) by a mounting element 630. The separation between the deformation-resistant planar patch antenna element 510 and the bottom surface of the cavity cell 614 is shown by a height dimension (H3). The deformation-resistant planar patch antenna element 510 in the isolated portion 622A is also coupled to and through the bottom surface of the cavity cell 614 by a linear polarization #1 excitation pin 632 and a linear polarization #2 excitation pin 634, configured and arranged as shown. The excitation pins 632, 634 provide two linear orthogonal polarizations (linear polarization #1 and linear polarization #2) to the feed network 410 (shown in FIG. 6A), and the feed network 410 provides the uniform amplitude and +/−90 degree phase difference from which the RHCP and the LHCP are generated. FIG. 6D is a simplified block diagram illustrating a top-down view of the isolated portion 622 (shown in FIGS. 6A and 6B) of the antenna structure 420B (shown in FIG. 6A) in accordance with embodiments of the disclosure. FIG. 6D illustrates embodiments of the disclosure where the cavity wall 618 surrounds portions of the deformation-resistant planar patch antenna element 510 and separates the deformation-resistant planar patch antenna element 510 shown in FIG. 6D from other adjacent instances of the deformation-resistant planar patch antenna element 510 in the antenna array structure 420B.

Inventors of the present disclosure have discovered that mutual coupling between the deformation-resistant planar patch antenna elements 510 of the dual-polarized hardness-reinforced antenna array structure 420B can be reduced without negatively impacting performance of the deformation-resistant planar patch antenna elements 510 by providing the cavity walls 618 (formed from deformation-resistant, non-dielectric material) and the cavity gaps 616, both of which having predetermined dimensions and locations. In general, mutual coupling is the electromagnetic interaction between the antenna elements in an antenna array. Mutual coupling behaves differently for an antenna operating in transmitting mode compared with an antenna operating in a receiving mode. The effect of mutual coupling between antenna elements in an antenna array can be significant if the spacing (S1 shown in FIG. 6A) between antenna elements is small (e.g., S1 shown in FIG. 6A less than or equal to about 10 mm). Mutual coupling can impact the performance of an antenna array in several ways, including changing the array radiation pattern, changing the array manifold (i.e., the received element voltages), and changing the impedance matching characteristic of the antenna elements.

In accordance with embodiments of the disclosure, the relevant dimensions for impacting mutual coupling without substantially degrading antenna performance include the height dimension H2 and the width dimension W2 of the cavity wall 618; the width dimension W1 of the cavity gap 616; and the height dimension H1 of the deformation-resistant planar patch antenna elements 510. In some embodiments of the disclosure, the height dimension H2 of the cavity wall 618 and the height dimension H1 of the deformation-resistant planar patch antenna elements 510 are set such that a top surface of the cavity wall 618 is below a top surface of the deformation-resistant planar patch antenna elements 510, substantially equal to a top surface of the deformation-resistant planar patch antenna elements 510, or above a top surface of the deformation-resistant planar patch antenna elements 510. In accordance with embodiments of the disclosure, the locations and dimensions of the cavity wall 618 and the cavity gap 616 avoid substantially interfering with or degrading performance of the deformation-resistant planar patch antenna elements 510 by limiting an impact each cavity wall 618 has on the far-field performance (e.g., the gain, the axial ratio, and the like) of its associated deformation-resistant planar patch antenna elements 510.

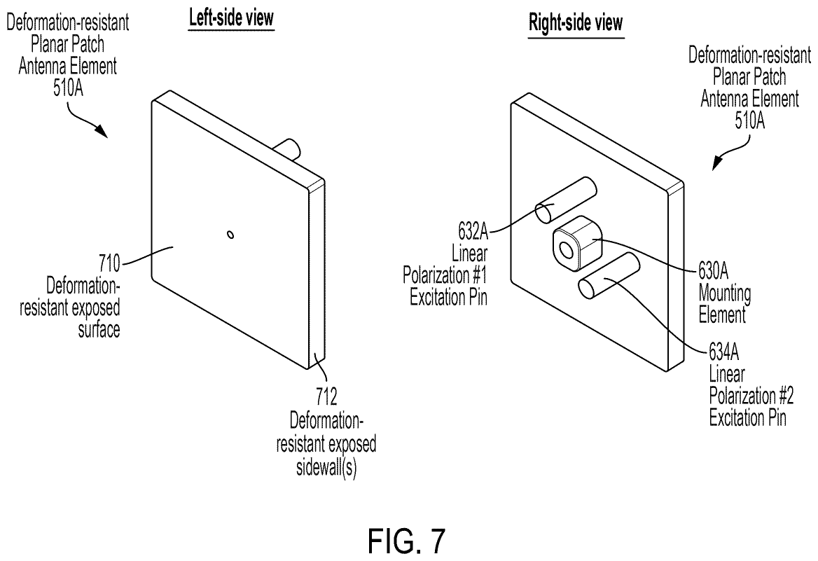

In accordance with embodiments of the disclosure, the cavity wall 618 and the cavity gap 616 reduce mutual coupling between the deformation-resistant planar patch antenna elements 510 of the antenna array structure 420B by impacting surface currents associated with the deformation-resistant planar patch antenna elements 510. The flow of charges on an antenna's surface determines the surface currents of the antenna. For antennas to radiate, there must be acceleration or deceleration of charges. The deceleration of charges is caused due to buildup of charges at the end of the antenna element, which leads to impedance discontinuities. In embodiments of the disclosure, the dimensions and locations of the cavity wall 618 and the cavity gap 616 between the adjacent instances of the deformation-resistant planar patch antenna elements 510 reduce the lateral propagation of surface currents and forces the surface currents to instead radiate away from the deformation-resistant planar patch antenna elements 510 (e.g., away from the excitation pins 632A, 634A shown in FIG. 7). In embodiments of the disclosure, the dimensions and locations of the cavity wall 618 and the cavity gap 616 between the adjacent instances of the deformation-resistant planar patch antenna elements 510 further improve the gain field of view for each of the deformation-resistant planar patch antenna elements 510. Wider gain field of view in this scenario means wider radiation patterns beam resulting in higher gain values at higher elevation angles. Accordingly, the locations and dimensions of the cavity wall 618 and the cavity gap 616 reduce mutual coupling between the adjacent instances of the deformation-resistant planar patch antenna elements 510 while improving radiation efficiency of the deformation-resistant planar patch antenna elements 510.

In some embodiments of the disclosure, the locations and dimensions of the cavity walls 618 and the cavity gaps 616 that reduce mutual coupling in the antenna array structure 420B without substantially interfering with the performance of the antenna array structure 420B as a signal receiving/transmitting antenna can be set up as an optimization problem and solved using an optimization problem solver. In some embodiments of the disclosure, the optimization problem solver can be incorporated within a simulation system operable to utilize computer-aided design (CAD) techniques to determine the locations and dimensions of the cavity walls 618 and the cavity gaps 616 that reduce mutual coupling in the antenna array structure 420B without substantially interfering with the performance of the antenna array structure 420B as a signal receiving/transmitting antenna.

FIG. 6E depicts a simulation system 640 operable to assist with generating locations and dimensions of the cavity walls 618 and the cavity gaps 616 that reduce mutual coupling between the deformation-resistant planar patch antenna elements 510 of the antenna array structure 420B while avoiding substantially interfering with or degrading performance of the deformation-resistant planar patch antenna elements 510 of the antenna array structure 420B. In general, the simulation system 640 includes an antenna array structure (AAS) (i.e., the antenna array structure 420B) configuration model 642, an environmental model 644, and an optimization problem solver 646, configured and arranged as shown. Inputs to the simulation system 640 include environmental parameters 650 representing an environment in which the AAS will operate, along with a proposed AAS configuration 660. The proposed AAS configuration 660 includes proposed location variables and dimension variables of the cavity walls 618 and the cavity gaps 616 that need to be optimized. In embodiments of the disclosure, the environment in which the AAS will operate includes a full range of multi-factor stressors that occur in unique and hard-to-predict environments, including, for example, exposure to the multi-factor stressors that exist in a tornado, in a hurricane, or in space. Outputs generated by the simulation system 640 include, for example mutual coupling simulations 670, which can include 2D and/or 3D video simulations of the mutual coupling of the antenna array structure 420B that would result from the AAS configuration 660 operating under the environmental parameters 650. Outputs generated by the simulation system 640 further include, for example AAS performance simulations 672, which can include 2D and/or 3D video simulations of the performance of the antenna array structure 420B that would result from the AAS configuration 660 operating under the environmental parameters 650. Outputs generated by the simulation system 640 further include, for example optimized AAS cavity wall/gap locations and dimensions 674 optimized to reduce mutual coupling between the deformation-resistant planar patch antenna elements 510 of the antenna array structure 420B while avoiding substantially interfering with or degrading performance of the deformation-resistant planar patch antenna elements 510 of the antenna array structure 420B.

In embodiments of the disclosure, the simulation system 640 includes computer-aided-design (CAD) functionality. CAD is the use of computer-based software to aid in design processes. CAD software is used by engineers and designers to create two-dimensional (2D) drawings or three-dimensional (3D) product-under-development (PUD) models. A purpose of CAD is to optimize and streamline the designer's workflow, increase productivity, improve the quality and level of detail in the design, improve documentation communications, and often contribute toward a manufacturing design database. CAD software outputs can be in the form of electronic files, which are used for manufacturing and/or fabrication processes. CAD can be used in tandem with digitized manufacturing/fabrication processes known as computer-aided manufacturing (CAM) processes. CAD/CAM software can be used to design a variety of products such as electronic circuit boards in computers and other devices. The simulation system 640 further includes CAD simulation functionality that allows virtual experiments to be performed on a PUD model instead of a physical prototype of the PUD.

The locations and dimensions of the cavity walls 618 and the cavity gaps 616 can be set up as variables of an optimization problem that can be solved using the optimization problem solver 646 of the simulation system 640. An optimization problem is one in which some function is either maximized or minimized relative to a given set of alternatives. An optimization problem can be organized under three general components, namely, an objective function, decision variables, and constraints. The objective function reflects one or more quantities to be either maximized or minimized. The decision variables, which can be represented as vectors, represent aspects of the problem that the entity formulating the optimization problem has control over. This can include both variables the entity can directly choose, as well as variables that the entity can indirectly influence by the choice of other decision variables. Every decision variable in the optimization problem formulation should either directly influence the objective function, or should influence another decision variable that affects the objective function. Constraints represent any kind of limitation on the values that the decision variables can take. The most intuitive types of constraints are those which directly and obviously limit the choices that can be made. For example, an integrated circuit design has a thermal budget constraint that limits the amount of heat that can be generated when the integrated circuit performs its various tasks.

In operation, the optimization problem solver 646 uses the inputs from the environmental parameters 650 and the AAS configuration 660 to propose optimized locations and dimensions of the cavity walls 618 and the cavity gaps 616 that reduce mutual coupling between the deformation-resistant planar patch antenna elements 510 of the antenna array structure 420B while avoiding substantially interfering with or degrading performance of the deformation-resistant planar patch antenna elements 510 of the antenna array structure 420B. The optimized locations and dimensions (i.e., optimized AAS cavity wall/gap locations and dimensions 674) of the cavity walls 618 and the cavity gaps 616 are used with the AAS configuration model 642 and the environmental model 644 to generate the mutual coupling simulation 670, the AAS performance simulation 672, and the associated optimized AAS cavity wall/gap locations and dimensions 674. In some embodiments of the disclosure, a user can evaluate the outputs of the simulation system 640 and make adjustments to the inputs to the simulation system 640 until the desired outputs (i.e., the mutual coupling simulations 660 and/or the AAS performance simulations 672) of the simulation system 640 are achieved.

In embodiments of the disclosure, the simulation system 640 is operable to utilize cognitive algorithms to perform the various data analysis and simulation/prediction operations described herein. In embodiments of the disclosure, a cognitive algorithm refers to a variety of algorithm types that generate and apply computerized models to simulate the human thought process in complex situations where the answers might be ambiguous and uncertain. A conventional cognitive algorithm includes self-learning technologies that use data mining, pattern recognition, natural language processing (NLP), and other related technologies to generate the mathematical models that make decisions (e.g., classifications, predictions, and the like) that, in effect, mimic human intelligence. In embodiments of the disclosure, the modifier “cognitive” as applied to “outputs” and/or “output actions” refers to the outputs, actions, and the like generated by cognitive algorithms to represent the result of the analysis operations performed by cognitive algorithms. A non-limiting example of a cognitive output action is predicting an impact (e.g., a reduction) on mutual coupling between the deformation-resistant planar patch antenna elements 510 that results from locations and dimensions of the cavity cell 614, cavity gap 616, and cavity wall 618 output by the optimization problem solver 646. Another non-limiting example of a cognitive output action is predicting an impact (e.g., a reduction) on performance of the deformation-resistant planar patch antenna elements 510 that results from locations and dimensions of the cavity cell 614, cavity gap 616, and cavity wall 618 output by the optimization problem solver 646.

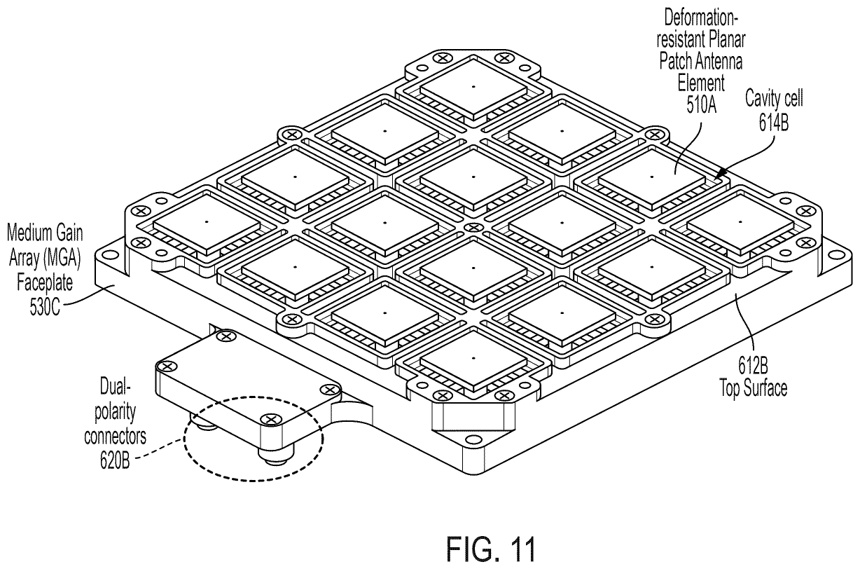

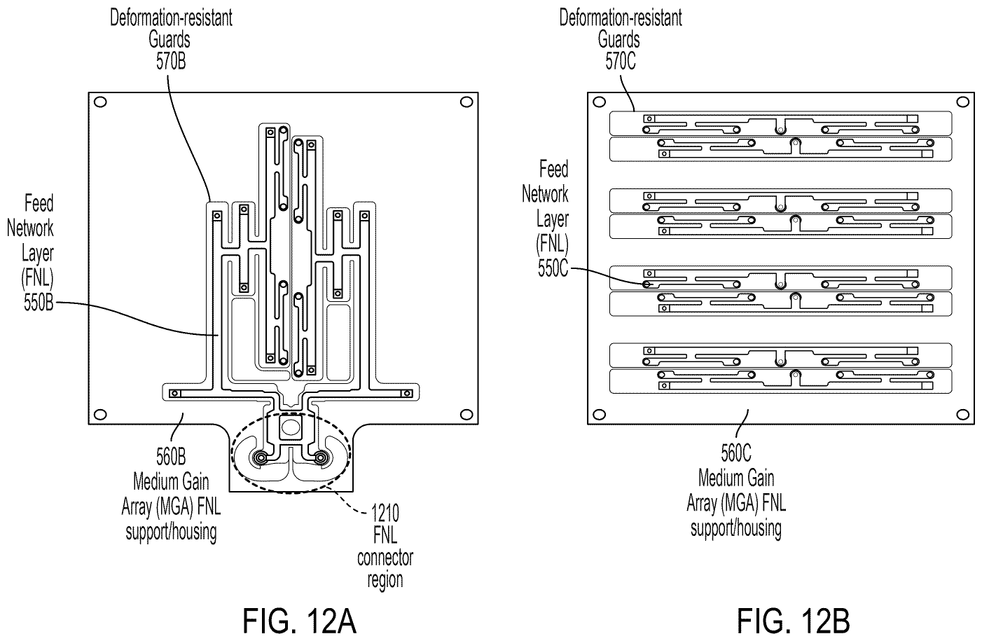

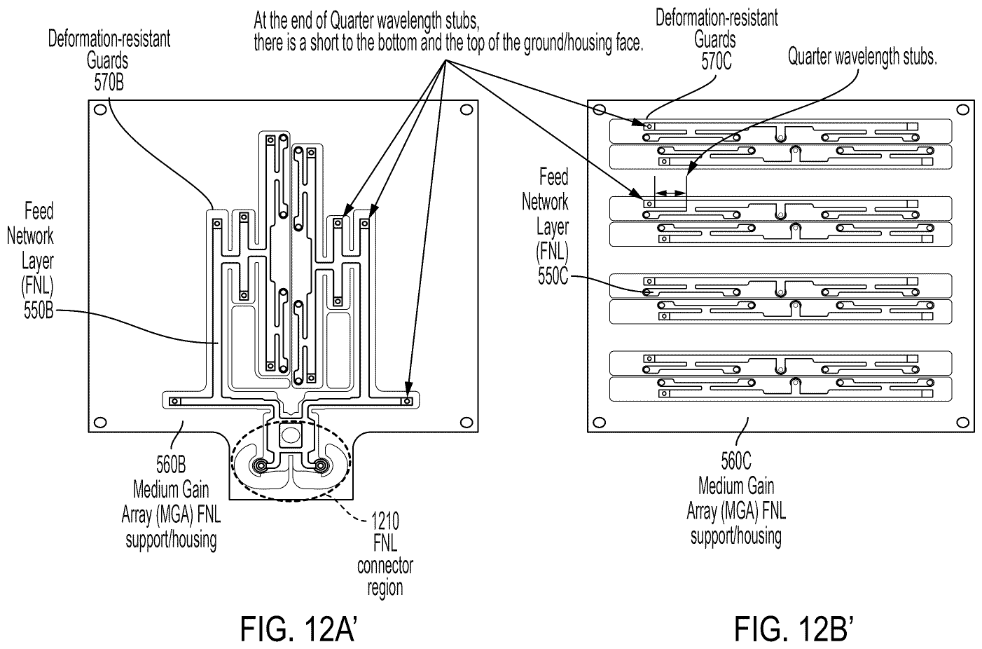

FIG. 7 is a simplified block diagram illustrating a non-limiting example of how the deformation resistant planar patch antenna 510 (shown in FIGS. 5 and 6) can be implemented as a deformation resistant planar patch antenna 510A in accordance with embodiments of the disclosure. FIG. 7 depicts a left-side view and a right-side view of the deformation-resistant planar patch antenna 510A. As best shown in the left-side view, the deformation-resistant planar patch antenna 510A includes a deformation-resistant exposed surface 710 and multiple deformation-resistant exposed sidewalls 712. As best shown in the right-side view, the deformation-resistant planar patch antenna 510A includes a mounting element 714, a RHCP pin 716A and a LHCP pin 716B, configured and arranged as shown. The mounting element 716A provides a structure for mechanically coupling the deformation-resistant planar patch antenna element 510 to a bottom surface of an associated one of the cavity cells 614 (shown in FIG. 5A). The mechanical coupling can be implemented through a variety of mechanisms, including but not limited to screws, glue, soldering, and the like. Where the deformation-resistant planar patch antenna 510 is implemented in a HGA version of the dual-polarized hardness-reinforced antenna array structure 420B (shown in FIG. 6A), the RHCP pin 716A is electronically coupled through a feed network layer 550A (shown in FIG. 9) to one of the dual-polarity connectors 620A (shown in FIG. 8); and the LHCP pin 716B is electronically coupled through the feed network layer 550A to one of the dual-polarity connectors 620A. Where the deformation-resistant planar patch antenna 510 is implemented in an MGA version of the dual-polarized hardness-reinforced antenna array structure 420B, the RHCP pin 716A is electronically coupled through a feed network layer(s) 550B, 550C (shown in FIGS. 12A and 12B) to one of the dual-polarity connectors 620B (shown in FIG. 11); and the LHCP pin 716B is electronically coupled through the feed network layer(s) 550B, 550C to one of the dual-polarity connectors 620B. In embodiments of the disclosure, a connection between the feed network layer 550B and the feed network layer 550C does not utilize a PCB-type via. The connection between the feed network layer 550B and the feed network layer 550C can be mechanically coupled to a non-dielectric substrate region of the feed network support via metallic pins, and the feed network support is mechanically coupled to the patch antennas via metallic patches' pins. These metallic pins are stronger compared to the PCB via to provide more mechanical support, handle higher temperature, and handle higher RF power without breaking.

In accordance with aspects of the disclosure, the deformation resistant planar patch antenna 510A can be formed from a deformation-resistant material such as a metal. In some embodiments of the disclosure, the weight of the deformation resistant planar patch antenna 510A can be reduced by forming the deformation resistant planar patch antenna 510A from a combination of a first deformation-resistant material and a second deformation-resistant material, where the deformation-resistance of the first deformation-resistant material is higher than the deformation-resistance of the second deformation-resistant material, while the weight of the first deformation-resistant material is greater than the weight of the second deformation-resistant material. In some embodiments of the disclosure, the entire the deformation-resistant planar patch antenna element 510A is formed from the first deformation-resistant material. In some embodiments of the disclosure, a main body region of the deformation-resistant planar patch antenna element 510A is formed from the second deformation-resistant material, and the exposed surfaces of the main body region of the deformation-resistant planar patch antenna element 510A component is formed from the second deformation-resistant material, thereby decreasing the overall weight of the deformation-resistant planar patch antenna element 510A while providing the higher deformation-resistance of the first deformation-resistant material.

FIG. 8 is a simplified block diagram illustrating how the faceplate 530A, cavity cells 614, dual polarity connectors 620, and the deformation-resistant planar patch antenna elements 510 (all of which are shown in FIG. 6A) can be implemented as an HGA faceplate 530B, cavity cells 614A, dual-polarity connectors 620A, and the deformation-resistant planar patch antenna elements 510A, configured and arranged as shown in FIG. 8. Similarly, FIG. 9 depicts a simplified block diagram illustrating how the feed network 410 (shown in FIG. 6A) can be implemented as an HGA feed network layer (FNL) support/housing 560A mechanically and electronically coupled to the HGA faceplate 530B. The HGA FNL support/housing 560A supports and/or houses deformation-resistant guards 570A and a FNL 550A. The FNL 550A includes an FNL connector region 910 operable to electronically connect the deformation-resistant planar patch antenna element 510A through the FNL 550A to the dual-polarity connectors 620A. In some embodiments of the disclosure, the FNL connector region 910 includes the hybrid quadrature(s) 580 (shown in FIG. 5A) and/or the 90 degree hybrid coupler 580A (shown in FIG. 5B). The deformation-resistant guards 570A are a non-limiting example of how the deformation resistant guards 570 (shown in FIG. 5A) can be implemented in accordance with aspects of the disclosure. The deformation-resistant guards 570A reduce mutual coupling between cells or sections of the FNL 550A. RF signals traveling through the FNL 550A radiate due to the impedance mismatch, traces' shape, and traces' discontinuity. A microstrip is a trace that is created in such a way as to allow it to behave like a transmission line. The impact of undesired radiation between the transmission lines is known as “mutual coupling,” which also can impact the impedance match and the overall performance of the array structure (e.g., array structures 420, 420A, 420B shown in FIGS. 4, 5A, 6A). To reduce the level of mutual coupling between transmission lines of the FNL 550A, metallic guards 570A are provided as shown in FIG. 9. Having metal guard structures 570A added in between cells of the FNL 550A decreases the radiated mutual coupling between the cells of the FNL 550A by re-directing the mutually coupled energy area away from the sensitive FNL 550A areas where the impedance mismatch can be affected. The FNL 550A is a non-limiting example of how the Deformation-resistant Microstrip 1-to-N corporate power dividers feed networks 550 can be implemented in accordance with aspects of the disclosure.

By making the antenna elements, 510, the faceplate 530, and the feed network layer 410 from a deformation-resistant non-dielectric material (e.g., a metal), a higher gain and more efficient array structure 420 can be achieved. Once the array structure 420 is made of a deformation-resistant non-dielectric material (e.g., a metal) without any PCB/dielectric material, no loss will be introduced compared to the antenna array designs with PCB/dielectric material added. Dielectric loss impacts both the antenna/array layer by reducing its radiation efficiency and the feed network layer because it adds losses to the RF travelling currents through the transmission lines/traces. These losses can be counted toward the overall or system radiation efficiency, which leads to reduced directivity, leading to lower gain. Therefore, embodiments of the disclosure improve the overall array gain and provide lower loss without increasing the number of antenna elements and array size by eliminating the dielectric material in the design. Having no dielectric material in the array structure 420 also helps reducing the risk of space discharging and ESD issues, which lead to damage to the transceiver circuit behind the antenna structure 420.

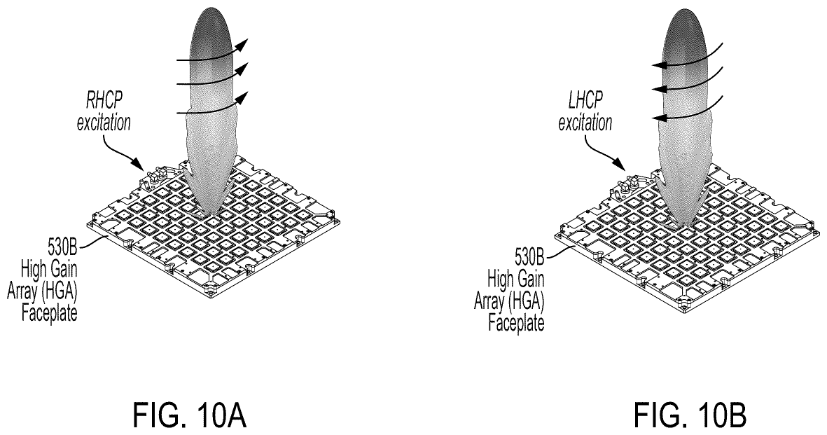

FIG. 10A is a simplified block diagram illustrating RHCP generated by each of the deformation-resistant planar patch antenna 510A (shown in FIG. 7) of the HGA faceplate 530B in accordance with embodiments of the disclosure. Similarly, FIG. 10B is a simplified block diagram illustrating LHCP generated by each of the deformation-resistant planar patch antenna 510A of the HGA faceplate 530B in accordance with embodiments of the disclosure. In electrodynamics, circular polarization of an electromagnetic wave is a polarization state in which, at each point, the electromagnetic field of the wave has a constant magnitude and is rotating at a constant rate in a plane perpendicular to the direction of the wave. In electrodynamics, the strength and direction of an electric field is defined by its electric field vector. In the case of a circularly polarized wave, the tip of the electric field vector, at a given point in space, relates to the phase of the light as it travels through time and space. At any instant of time, the electric field vector of the wave indicates a point on a helix oriented along the direction of propagation. A circularly polarized wave can rotate in one of two possible senses, namely RHCP (shown in FIG. 10A) in which the electric field vector rotates in a right-hand sense with respect to the direction of propagation, and LHCP (shown in FIG. 10B). in which the vector rotates in a left-hand sense. In accordance with aspects of the disclosure, the HGA faceplate 530B is configured and arranged such that a single deformation-resistant planar patch antenna 510A can transmit and receive both RHCP signals and LHCP signals.

FIG. 11 is a simplified block diagram illustrating how the faceplate 530A, cavity cells 614, dual polarity connectors 620, and the deformation-resistant planar patch antenna elements 510 (all of which are shown in FIG. 6A) can be implemented as an MGA faceplate 530C, cavity cells 614B, dual-polarity connectors 620B, and the deformation-resistant planar patch antenna elements 510A, configured and arranged as shown. Similarly, FIGS. 12A and 12B depict simplified block diagrams illustrating how the feed network 410 (shown in FIG. 6A) can be implemented as an MGA feed network layer (FNL) support/housing 560B that supports and/or houses a FNL 550B, along with an MGA FNL support/housing 560C that supports and/or houses a FNL 550C. The FNL 550B includes deformation-resistant guards 570B operable to reduce mutual coupling between cells of the FNL 550B. Similarly, the FNL 550C includes deformation-resistant guards 570C operable to reduce mutual coupling between cells of the FNL 550C. The FNL 550B includes an FNL connector region 1210 operable to electronically connect the deformation-resistant planar patch antenna element 510A through the FNL 550B to the dual-polarity connectors 620B. In some embodiments of the disclosure, the FNL connector region 1210 includes the hybrid quadrature(s) 580 (shown in FIG. 5A) and/or the 90 degree hybrid coupler 580A (shown in FIG. 5B). The FNL 550B and the FNL 55C are non-limiting examples of how the Deformation-resistant Microstrip 1-to-N corporate power dividers feed networks 550 can be implemented as two FNLs 550B, 550C in accordance with aspects of the disclosure.

The MGA-implementation of the feed network 410 of the antenna structure 420 is designed in embodiments of disclosure to be multilayer RF striplines instead of microstrip lines. Microstrip lines are typically formed on top of a dielectric substrate, which is formed on top of a ground plane. Striplines have feed network traces and are typically positioned with a dielectric substrate, which is positioned between a first reference/ground plane and a second reference/ground plane. Embodiments of the disclosure use the microstrip configuration (with PCB) for the HGA implementation that uses a FNL in PCB housing. While for the MGA implementation, a stripline configuration is used with no dielectric to decrease the loss. The use of the multilayer metal stripline configuration provides low losses compared to the dielectric stripline PCB configuration. Also, the shorted stubs design helps to support the stripline metal traces (shown in FIGS. 12A and 12B).

The sixteen (16) deformation-resistant planar patch antenna elements 510A are mounted on the MGA faceplate 530C through excitation pins 632A, 634A to enable the dual polarization capability. In some embodiments of the disclosure, each of the excitation pins 632A, 634A is soldered to eight all-metal strip lines 1-to-4 corporate power dividers feed networks FNL 550C. The FNL 550C is then soldered to the second layer all-metal strip lines feed corporate power dividers FNL 550B. The second Layer FNL 550B includes a quadrature hybrid feed network (e.g., quadrature hybrid(s) 580, 580A shown in FIGS. 5A and 5B), which provides the +/−90 degree phase different and allows the RHCP and LHCP capability. The quadrature hybrid of the FNL 550B can be connected through the FNL connector region 1210 to the dual-polarity connectors 620B, which includes one connector for RHCP and the other connector to excite LHCP. In the MGA implementation shown in FIGS. 12A, 12B, there are two FNL housings 560B, 560C. The two FNL housings 560B, 560C protect the FNLs 550B, 550C rom any damage during MGA installation, mitigate the feed network coupling to the nearby antennas located on SC, and protect the feed networks 550B, 550C from any ESD (electrostatic discharge) or charge accumulation. The two FNL housings 560B, 560C also help to provide the grounding to enable the strip lines RF design without any dielectric.

The two FNLs 550B, 550C are shorted and mounted to the housing, which means that no dielectric is needed for support while maintaining the RF impedance lines, amplitude and required phases. Embodiments of the disclosure provide no dielectric material to support the traces that form the FNLs 550B, 550C. Embodiments of the disclosure further provide an additional layer of DC short to ground to further protect the connectors, cables, and other circuitry behind the faceplate 530C from any ESD or discharging issue. In order to achieve these two features, all-metal quarter wavelength shorted stubs (shown in FIGS. 12A′ and 12B′) are utilized to provide enough support to these all-metal traces instead of having them hanging without any mechanical support. These quarter wavelength shorted stubs would not impact the impedance match of the traces that form the FNLs 550B, 550C because at the shorted end-of-line stub the impedance is zero, but after the quarter wave stub transformation the traces that form the FNLs 550B, 550C will see infinite impedance at the connection point between the traces that form the FNLs 550B, 550C and these additional stubs. Therefore, the RF signals once they travel through the traces that form the FNLs 550B, 550C will not enter these shorted stubs because they see open circuit stub with infinite impedance. Therefore, no desired RF signal will leak to the stub. FIGS. 12A′ and 12B′ show the location of an example of one of the stubs, and where the short is located.

For antenna array designs that mount the antenna elements in dielectric substrate material using PCB fabrication techniques, a single layer of dielectric/PCB material is used instead of a multilayer stacked dielectric PCB material design to decrease the loss. However, with the deformation-resistant MGA design depicted in FIGS. 11, 12A, 12B, the multi-layer FNL strip lines configuration (FNLs 550B, 550C) can be utilized because no loss will be added due to the lack of PCB dielectric material, which further leads to having a more efficient and robust antenna array that can be implemented in a smaller footprint (e.g., in X-Y dimensions).

As previously noted herein, each feature and functionality described in connection with the HGA implementations of embodiments of the disclosure apply equally to the MGA implementations of embodiments of the disclosure, and vice versa. Specifically, it is noted that the features and functionality related to the relationship between the cavity cell 614, the cavity gap 616, the cavity sidewalls 618, and the deformation-resistant planar patch antenna 510 as reflected in FIGS. 6A-6E apply equally to the MGA implementations (shown in FIGS. 11, 12A, 12B, 13A, and 13B) of the dual-polarized hardness-reinforced antenna array structure 420B.

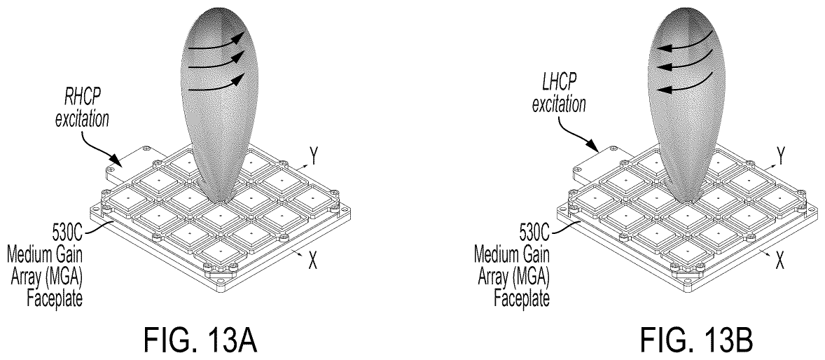

FIG. 13A is a simplified block diagram illustrating RHCP generated by each of the deformation-resistant planar patch antenna 510A (shown in FIG. 7) of the MGA faceplate 530C in accordance with embodiments of the disclosure. Similarly, FIG. 13B is a simplified block diagram illustrating LHCP generated by each of the deformation-resistant planar patch antenna 510A of the MGA faceplate 530C in accordance with embodiments of the disclosure. In electrodynamics, circular polarization of an electromagnetic wave is a polarization state in which, at each point, the electromagnetic field of the wave has a constant magnitude and is rotating at a constant rate in a plane perpendicular to the direction of the wave. In electrodynamics, the strength and direction of an electric field is defined by its electric field vector. In the case of a circularly polarized wave, the tip of the electric field vector, at a given point in space, relates to the phase of the light as it travels through time and space. At any instant of time, the electric field vector of the wave indicates a point on a helix oriented along the direction of propagation. A circularly polarized wave can rotate in one of two possible senses, namely RHCP (shown in FIG. 13A) in which the electric field vector rotates in a right-hand sense with respect to the direction of propagation, and LHCP (shown in FIG. 13B). in which the vector rotates in a left-hand sense. In accordance with aspects of the disclosure, the MGA faceplate 530C is configured and arranged such that a single deformation-resistant planar patch antenna 510A can transmit and receive both RHCP signals and LHCP signals.

FIG. 14 illustrates an example of a computer system 1400 that can be used to implement the computer-based components in accordance with aspects of the disclosure. The computer system 1400 includes an exemplary computing device (“computer”) 1402 configured for performing various aspects of the content-based semantic monitoring operations described herein in accordance aspects of the disclosure. In addition to computer 1402, exemplary computer system 1400 includes network 1414, which connects computer 1402 to additional systems (not depicted) and can include one or more wide area networks (WANs) and/or local area networks (LANs) such as the Internet, intranet(s), and/or wireless communication network(s). Computer 1402 and additional systems are in communication via network 1414, e.g., to communicate data between them.

Exemplary computer 1402 includes processor cores 1404, main memory (“memory”) 1410, and input/output component(s) 1412, which are in communication via bus 1403. Processor cores 1404 includes cache memory (“cache”) 1406 and controls 1408, which include branch prediction structures and associated search, hit, detect and update logic, which will be described in more detail below. Cache 1406 can include multiple cache levels (not depicted) that are on or off-chip from processor 1404. Memory 1410 can include various data stored therein, e.g., instructions, software, routines, etc., which, e.g., can be transferred to/from cache 1406 by controls 1408 for execution by processor 1404. Input/output component(s) 1412 can include one or more components that facilitate local and/or remote input/output operations to/from computer 1402, such as a display, keyboard, modem, network adapter, etc. (not depicted).

A cloud computing system 50 is in wired or wireless electronic communication with the computer system 1400. The cloud computing system 50 can supplement, support or replace some or all of the functionality (in any combination) of the computing system 1400. Additionally, some or all of the functionality of the computer system 1400 can be implemented as a node of the cloud computing system 50.

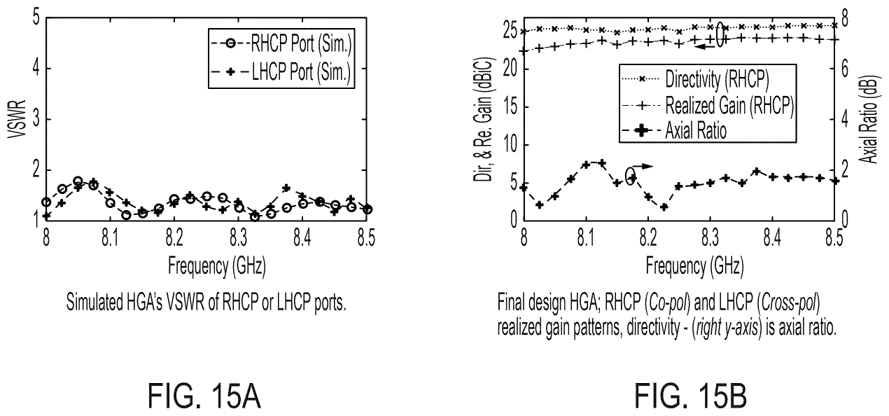

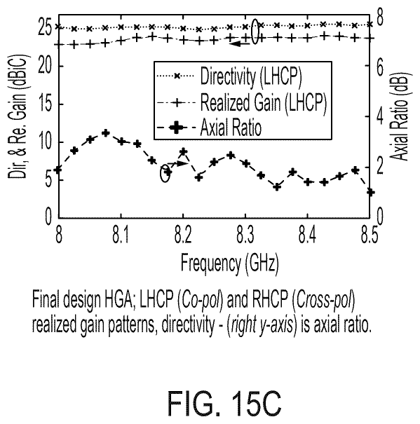

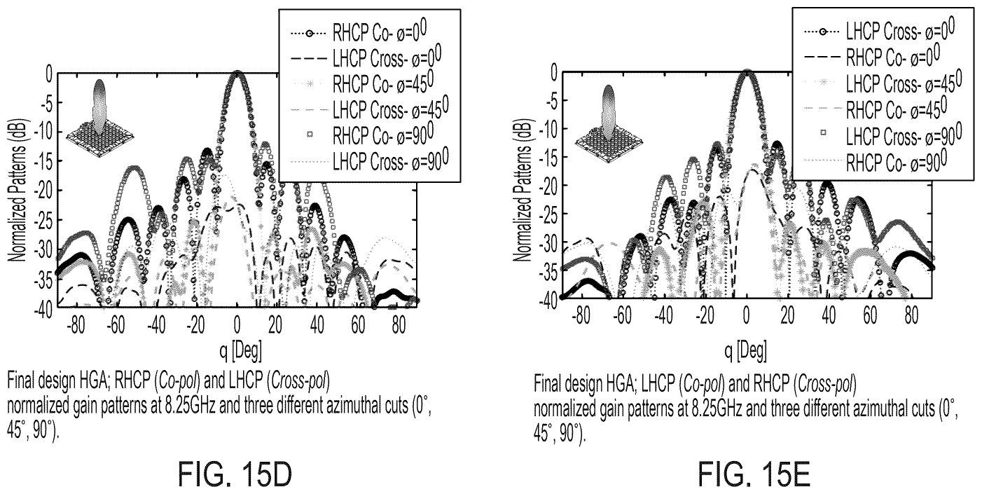

FIGS. 15A-15E illustrate results of simulations showing functionality of an HGA implementation of the dual-polarized hardness-reinforced antenna array 420 (shown in FIG. 4). The RF performance of the HGA implementation is shown in FIG. 15A. The simulated RHCP and LHCP ports are matched to 50106 impedance, similar VSWRs <1.8 performance over the bandwidth of interest is achieved for both polarizations as shown in FIG. 15B. The 3D radiation patterns with the array in the back view (shown in FIGS. 13A, 13B) are provided as a reference. As depicted, the pattern looks symmetric around different azimuthal cuts. FIGS. 15D and 15E illustrates very similar RHCP and LHCP min/max gains 22.3/23.9 dBiC and axials ratio <3.6 dB are obtained. Because the feed network and connectors are included in the simulation, some loss is introduced mainly due to the PCB material, and it can be seen once comparing the gain to directivity levels min/max 24.9/25.6 dB. The normalized co-pol radiation patterns at 8.25 GHz are still good over three different azimuthal cuts with low side lobes and cross-polarization level, FIGS. 15D and 15E.

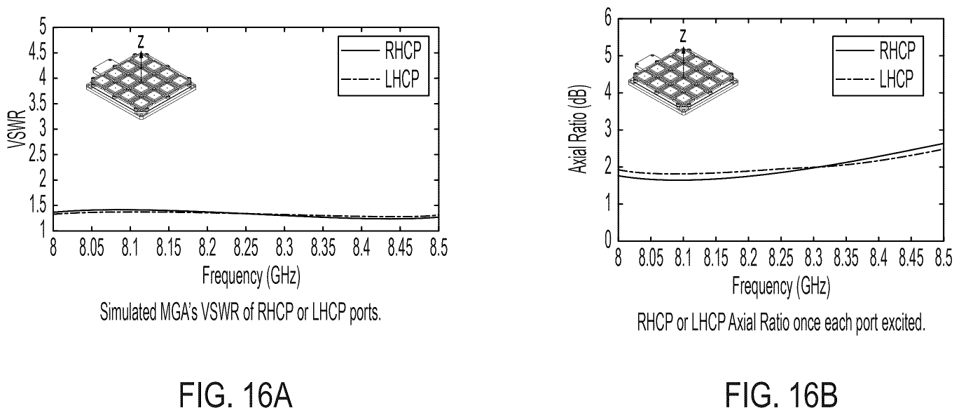

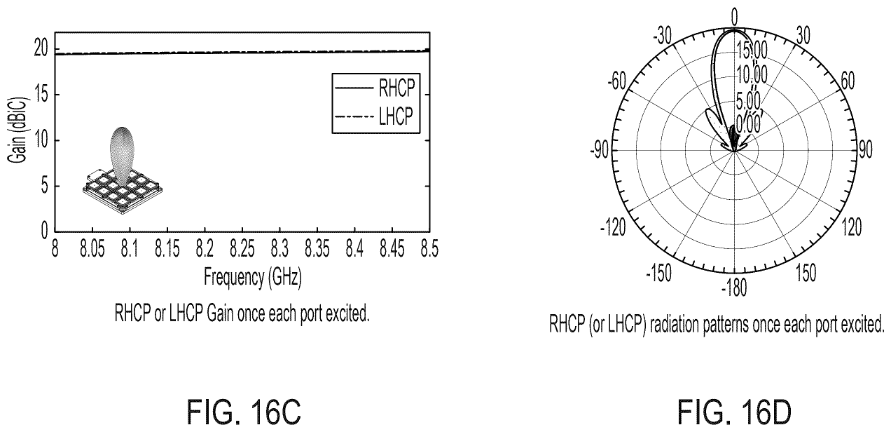

FIGS. 16A-16D illustrate results of simulations showing functionality of an MGA implementation of the dual-polarized hardness-reinforced antenna array 420 (shown in FIG. 4). The RF performance of the MGA implementation is shown in FIG. 16A. The simulated RHCP and LHCP ports are matched to 50Ω impedance, similar VSWRs <1.8 performance over the bandwidth of interest is achieved for both polarizations as shown in FIG. 16A. The 3D radiation patterns with the array in the back view is shown in FIG. 16C as a reference. Clearly, the pattern looks symmetric around different azimuthal cuts. FIG. 16C, 16B illustrates very similar RHCP and LHCP min/max gains ˜19 dBiC and axials ratio <3 dB are obtained, respectively. The normalized co-pol radiation patterns at 8.25 GHz still good over three different azimuthal cuts with low side lobes and cross-polarization level is shown in FIG. 16D.

Accordingly, it can be seen from the foregoing detailed description that embodiments of the disclosure provide technical effects and technical benefits. Embodiments of the disclosure provide a dual-polarized, hardness-reinforced antenna array for use in harsh environments. In some embodiments of the disclosure, the hardness-reinforced antenna array includes a deformation resistant material such as a metal; and the harsh environment includes a deep-space environment. The dual-polarized, hardness-reinforced antenna array can be implemented as an antenna structure that includes one or more antenna elements mechanically coupled to a non-dielectric substrate region of a faceplate. The antenna structure can further include a dual-polarity coupler electronically coupled to the one or more antenna elements. The dual polarity coupler is operable to transmit a first type of electronic communication having a first polarity type (e.g., RHCP), as well as a second type of electronic communication have a second polarity type (e.g., LHCP). The one or more antenna elements can further include exposed surfaces that include a first deformation resistant material (e.g., a metal, a metal allow, and the like). The dual-polarity coupler electronically coupled to the one or more antenna elements enables the one or more antenna elements to transmit/receive multiple polarity types, thereby improving the frequency bandwidth capability of an individual antenna element and eliminating the additional cost, size and weight that would result from providing a dedicated antennal element for each polarity type. By forming the faceplate such that it includes no dielectric material, electrostatic discharge is mitigated, and each antenna element's ability to withstand extreme cold/hot temperatures and the impact of high particle radiation levels is improved.

In embodiments of the disclosure, the non-dielectric substrate region of the faceplate has formed therein a plurality of cavity cells, and each of the deformation-resistant dual-polarized patch antenna elements is secured inside one of the cavity cells by mechanically coupling the deformation-resistant planar dual-polarity patch antenna element to a bottom surface of its corresponding cavity cell. In embodiments of the disclosure, the deformation-resistant dual-polarity antenna element is sized such that it does not completely fill its associated cavity cell and is spaced away from one or more sidewalls of the cavity cell, thereby forming at least one cavity gap between the deformation-resistant dual-polarity patch antenna element and one or more sidewalls of the cavity cell. Accordingly, each deformation-resistant, dual-polarity antenna element is separated from other deformation-resistant, dual-polarity antenna elements in the array by a gap (or air gap) and a cavity sidewall. In embodiments of the disclosure, the dimensions and locations of the cavity gaps and cavity sidewalls are selected to decrease the non-desired coupling from one deformation-resistant dual-polarity antenna element in the antenna array to the surrounding deformation-resistant dual-polarity antenna elements in the antenna array. In embodiments of the disclosure, the dimensions and locations of the cavity gaps and cavity sidewalls are further selected such that the cavity sidewalls and cavity gaps do not negatively impact the performance of each deformation-resistant, dual-polarity antenna element in the array.

The above-described antenna structure further includes a feed network electronically coupled between the dual-polarity coupler and the antenna element, where the feed network includes a second deformation resistant material. The feed network can be mechanically coupled to a non-dielectric substrate region of a feed network support, and the feed network support is mechanically coupled to the faceplate. The antenna structure can further include a backplane housing mechanically coupled to the feed network support, where the backplane housing includes a third deformation resistant material. In some embodiments of the disclosure, some or all of the feed network support is formed from material that is both deformation-resistant and non-dielectric material. Non-dielectric material in the feed network support mitigates the impact of electrostatic discharge, extreme cold/hot temperature conditions, and high particle radiation levels on antenna performance and the material's structural integrity. More specifically, forming the feed network housing from material that is deformation-resistant material and non-dielectric (e.g., one or more types of a metal or a metal alloy) helps to reduce the negative antenna performance that can result from the frequency shifting that results from the presence of dielectric materials in the antenna structure.

In some embodiments of disclosure, the feed network is provided in a single layer that is mechanically coupled to one side of the feed network housing. In some embodiments of disclosure, the feed network is provided in two layers, where a first one of the two layers is mechanically coupled to a first side of the feed network housing, and where a second one of the two layers is mechanically coupled to a second, opposite side of the feed network housing. In either the single layer feed network or the two layer feed network, the need for vias connecting multiple feed network layers is eliminated, which decreases the risk of thermal and vibration failure during the actual mission, spacecraft lunching, or through qualifications testing. In embodiments of the disclosure where the one or more layers of the feed network are mechanically mounted to a non-dielectric deformation-resistant feed network housing, metal guards are provided at selected locations of the feed network to reduce mutual coupling between sections of the feed network.

The optional deformation-resistant backplane housing can be mechanically coupled to a back end/side of the feed network housing to reduce to reduce the radiation coupling to other nearby antennas (e.g., other antennas on the deep-mission station 150 shown in FIG. 1) and provide extra environmental protection to the feed network. To decrease the complexity and weight, this backplane housing can be removed from the design.

Some aspects of the disclosure utilize techniques used in the fabrication of semiconductor-based structures and devices on wafer substrates. For example, some embodiments of the disclosure use semiconductor-based fabrication techniques to form various elements (e.g., feed elements of a feed network) in a dielectric substrate that forms part of a feed network housing. For the sake of brevity, conventional techniques related to semiconductor device and IC fabrication are well known so may or may not be described in detail herein. By way of background, however, a more general description of the semiconductor device fabrication processes that can be utilized in implementing one or more embodiments of the present disclosure include the various processes used to form a micro-chip that will be packaged into an IC. These semiconductor device fabrication techniques fall into three general categories, namely, film deposition, removal/etching, and patterning/lithography. Deposition is any process that grows, coats, or otherwise transfers a material onto the wafer/substrate. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), chemical-mechanical planarization (CMP), and the like. Reactive ion etching (RIE), for example, is a type of dry etching that uses chemically reactive plasma to remove a material, such as a masked pattern of semiconductor material, by exposing the material to a bombardment of ions that dislodge portions of the material from the exposed surface. The plasma is typically generated under low pressure (vacuum) by an electromagnetic field. Films of both conductors (e.g., poly-silicon, aluminum, copper, etc.) and insulators (e.g., various forms of silicon dioxide, silicon nitride, etc.) are used to connect and isolate conductive components. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a semiconductor device and the many wires that connect the millions of semiconductor device of a circuit, lithography and etch pattern transfer steps are repeated multiple times. Each pattern being printed on the wafer is aligned to the previously formed patterns and slowly the conductors, insulators and other structures are built up to form the final device.

Many of the functional units of the systems described in this specification have been labeled as modules. Embodiments of the disclosure apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

The various components/modules/models of the systems illustrated herein are depicted separately for ease of illustration and explanation. In embodiments of the disclosure, the functions performed by the various components/modules/models can be distributed differently than shown without departing from the scope of the various embodiments of the disclosure describe herein unless it is specifically stated otherwise.

Aspects of the disclosure can be embodied as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The terms “about,” “substantially,” “substantial,” “approximately,” and equivalents thereof are intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An antenna structure comprising:
antenna elements mechanically coupled to a non-dielectric substrate region of a faceplate; and
a dual-polarity coupler electronically coupled to the antenna elements;
wherein the dual polarity coupler is operable to transmit:
a first type of electronic communication having a first polarity type; and
a second type of electronic communication have a second polarity type;
wherein the antenna elements comprises exposed surfaces; and
wherein the exposed surfaces of the antenna elements comprise a first deformation resistant material.

2. The antenna structure of claim 1 further comprising a feed network electronically coupled between the dual-polarity coupler and the antenna elements, wherein the feed network comprises a second deformation resistant material.

3. The antenna structure of claim 2, wherein:
the feed network is mechanically coupled to a dielectric substrate region of a feed network support; and
the feed network support is mechanically coupled to the faceplate.

4. The antenna structure of claim 2, wherein:
the feed network is mechanically coupled to a non-dielectric substrate region of a feed network support; and
the feed network support is mechanically coupled to the faceplate.

5. The antenna structure of claim 4 further comprising a backplane housing mechanically coupled to the feed network support, wherein the backplane housing comprises a third deformation resistant material.

6. The antenna structure of claim 5, wherein:
the first deformation resistant material comprises a first metal material;
the second deformation resistant material comprises a second metal material: and
the third deformation resistant material comprises a third metal material.

7. The antenna structure of claim 1, wherein:
the antenna elements comprise a first antenna element and a second antenna element;
the non-dielectric substrate region of the faceplate comprises a first cavity having cavity sidewalls; and
the first antenna element is mechanically coupled to the non-dielectric substrate region of the faceplate through the first cavity such that a first cavity gap is defined between the first antenna element and the cavity sidewalls;
wherein a portion of the cavity sidewalls and a portion of the first cavity gap are between the first antenna element and the second antenna element; and
wherein the portion of the first cavity sidewalls is operable to reduce mutual coupling between the first antenna element and the second antenna element.

8. An antenna structure comprising:
an antenna array comprising antenna elements mechanically coupled to a non-dielectric substrate region of a faceplate; and
a dual-polarity coupler electronically coupled to the antenna elements;
wherein the dual polarity coupler is operable to transmit:
a first type of electronic communication having a first polarity type; and
a second type of electronic communication have a second polarity type;
wherein each of the antenna elements comprises exposed surfaces; and
wherein the exposed surfaces of each of the antenna elements comprise one or more types of a first deformation resistant material.

9. The antenna structure of claim 8 further comprising a feed network electronically coupled between the dual-polarity coupler and the antenna elements, wherein the feed network comprises one or more types of a second deformation resistant material.

10. The antenna structure of claim 9, wherein:
the feed network is mechanically coupled to a dielectric substrate region of a feed network support; and
the feed network support is mechanically coupled to the faceplate.

11. The antenna structure of claim 9, wherein:
the feed network comprises a first feed network layer and a second feed network layer;
a connection between the feed network and the second feed network layer does not comprises a via;
the feed network is mechanically coupled to a non-dielectric substrate region of a feed network support; and
the feed network support is mechanically coupled to the faceplate.

12. The antenna structure of claim 9, wherein:
the feed network is mechanically coupled to a non-dielectric substrate region of a feed network support;
the feed network support is mechanically coupled to the faceplate;
the antenna structure further comprises a backplane housing mechanically coupled to the feed network support; and
the backplane housing comprises one or more types of a third deformation resistant material.

13. The antenna structure of claim 12, wherein:
the first deformation resistant material comprises a first metal material;
the second deformation resistant material comprises a second metal material: and
the third deformation resistant material comprises a third metal material.

14. The antenna structure of claim 8, wherein:
the antenna elements comprise a first antenna element and a second antennal element;
the non-dielectric substrate region of the faceplate comprises a top surface having a first cavity and a second cavity;
the first antenna element is mechanically coupled to the non-dielectric substrate region of the faceplate through the first cavity; and
the second antenna element is mechanically coupled to the non-dielectric substrate region of the faceplate through the second cavity.

15. A method of forming an antenna structure, the method comprising:
forming an antenna array comprising antenna elements mechanically coupled to a non-dielectric substrate region of a faceplate; and
electronically coupling a dual-polarity coupler to the antenna elements;
wherein the dual polarity coupler is operable to transmit:
a first type of electronic communication having a first polarity type; and
a second type of electronic communication have a second polarity type;
wherein each of the antenna elements comprises exposed surfaces; and
wherein the exposed surfaces of each of the antenna elements comprise one or more types of a first deformation resistant material.

16. The method of claim 15 further comprising electronically coupling a feed network between the dual-polarity coupler and the antenna elements, wherein the feed network comprises one or more types of a second deformation resistant material.

17. The method of claim 16, wherein:
the feed network is mechanically coupled to a dielectric substrate region of a feed network support; and
the feed network support is mechanically coupled to the faceplate.

18. The method of claim 16, wherein:
the feed network is mechanically coupled to a non-dielectric substrate region of a feed network support; and
the feed network support is mechanically coupled to the faceplate.

19. The method of claim 16, wherein:
the first deformation resistant material comprises a first metal material;
the second deformation resistant material comprises a second metal material.

20. The method of claim 15, wherein:
the antenna elements comprise a first antenna element and a second antennal element;
the non-dielectric substrate region of the faceplate comprises a top surface having a first cavity and a second cavity;
the first antenna element is mechanically coupled to the non-dielectric substrate region of the faceplate through the first cavity; and
the second antenna element is mechanically coupled to the non-dielectric substrate region of the faceplate through the second cavity.
